(19) United States
(12) Patent Application Publication
(10) Pub. No.: US 2025/0056622 A1
(43) Pub. Date: Feb. 13, 2025

(54) SYSTEMS AND METHODS FOR PERFORMING INITIAL CLUSTERING IN CELL-FREE NETWORKS

(71) Applicant: APPLE INC., Cupertino, CA (US)

(72) Inventors: Ahmed Gamal Helmy Mohamed, Cupertino, CA (US); Firouz Behnamfar, Los Gatos, CA (US); Ayman F. Naguib, Cupertino, CA (US); Danila Zaev, Munich (DE)

(21) Appl. No.: 18/794,790

(22) Filed: Aug. 5, 2024

Related U.S. Application Data
(60) Provisional application No. 63/518,628, filed on Aug. 10, 2023.

(51) Int. Cl. H04W 74/0833

(52) U.S. Cl. CPC H04W 74/0833

(57) ABSTRACT

Systems and methods for clustering in cell-free networks are described herein. A cluster of one or more base stations provides radio access network (RAN) functionality to a user equipment (UE) within the wireless communication system in a cell-free manner (e.g., without using a base-station-centric cell context, as in prior wireless communication systems). A cluster that is serving a UE comprises one or more connected base stations (cBSs) that actively serve the UE. A clustering control function (CCF) of the network establishes and maintains the cluster that is serving one or more UEs. Herein, messaging systems and messaging types used by the CCF, base station(s), and UE(s) within this cell-free context are discussed. Initial clustering methods used by a CCF to form a cluster for a UE are discussed. Further, clustering update methods used by a CCF to maintain/modify a cluster for a UE are discussed.

### TECHNICAL FIELD

This application relates generally to wireless communication systems, including wireless communication systems that utilize clustering in a cell-free context.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN). Sixth generation RANs are also contemplated.

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB). Sixth generation base stations are also contemplated.

A RAN provides its communication services with external entities through its connection to a core network (CN). For example, E-UTRAN may utilize an Evolved Packet Core (EPC) while NG-RAN may utilize a 5G Core Network (5GC). Sixth generation CNs are also contemplated.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram of a wireless communication system that operates in a cell-free manner, according to embodiments discussed herein.

FIG. 2 illustrates a diagram showing a first UE that is served by a first cluster and a second UE that is served by a second cluster, according to embodiments discussed herein.

FIG. 3 illustrates a table of various message types that may be used in a wireless communication system implementing cell-free, cluster-based operations as described herein.

FIG. 4 illustrates a flow diagram for a messaging exchange for a clustering decision controlled by a CCF with respect to a UE, according to embodiments discussed herein.

FIG. 5 illustrates a first example arrangement of clusters that is possible within a wireless communication system having base stations that implement a CU/DU split.

FIG. 6 illustrates a second example arrangement of clusters that is possible within a wireless communication system having base stations that implement a CU/DU split.

FIG. 7 illustrates a third example arrangement of clusters that is possible within a wireless communication system having base stations that implement a CU/DU split.

FIG. 8 illustrates a fourth example arrangement of clusters that is possible within a wireless communication system having base stations that implement a CU/DU split.

FIG. 9 illustrates a fifth example arrangement of clusters that is possible within a wireless communication system having base stations that implement a CU/DU split.

FIG. 10 illustrates a sixth example arrangement of clusters that is possible within a wireless communication system having base stations that implement a CU/DU split.

FIG. 11 illustrates a method of a greedy algorithm for performing initial clustering, according to embodiments discussed herein.

FIG. 12 illustrates a flow diagram corresponding to a RACH procedure between a UE and a network, attendant to a DL-based algorithm for initial clustering, as discussed in embodiments herein.

FIG. 13 illustrates a method of a CCF of a wireless communication system, according to embodiments discussed herein.

FIG. 14 illustrates a method of a cBS of a wireless communication system, according to embodiments discussed herein.

FIG. 15 illustrates a method of a uBS that is not in a cluster of a wireless communication that is serving a UE, according to embodiments discussed herein.

FIG. 16 illustrates a method of a UE in a wireless communication system, according to embodiments discussed herein.

FIG. 17 illustrates a method of a CCF of a wireless communication system, according to embodiments discussed herein.

FIG. 18 illustrates a method of a CCF of a wireless communication system, according to embodiments discussed herein.

FIG. 19 illustrates a method of a base station of a wireless communication system, according to embodiments discussed herein.

FIG. 20 illustrates a method of a CCF of a wireless communication system, according to embodiments discussed herein.

FIG. 21 illustrates a method of a CCF of a wireless communication system, according to embodiments discussed herein.

FIG. 22 illustrates a method of a CCF of a wireless communication system, according to embodiments discussed herein.

FIG. 23 illustrates an example architecture of a wireless communication system, according to embodiments disclosed herein.

FIG. 24 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In legacy wireless communication systems (e.g., LTE and/or 5G wireless communications systems, as presently understood), neighbor base stations are understood to operate one or more cells within which UEs of the wireless communication system may operate. Within this cell context, these base stations coordinate with each other and perform joint scheduling and joint/coordinated beamforming for shared channels. As one example of an application of this cell context, it may be understood that control information for the UE with respect to communication within the wireless communication system may be delivered by a serving cell for the UE that is one cell among many on which the UE may communicate.

It is contemplated that future wireless communication systems (e.g., sixth generation or “6G” wireless communication systems) may be implemented in a cell-free manner/configured to operate in a cell-free context. In cell-free networks of such wireless communication systems, a dense deployment within a “freely-planned” network may be contemplated, where sectors may overlap each other, and where a UE is typically located in the coverage of multiple base stations (where the base stations serving the UE are understood as a “cluster”). This introduces a new concept of a UE-centric “cluster” or “serving cluster”).

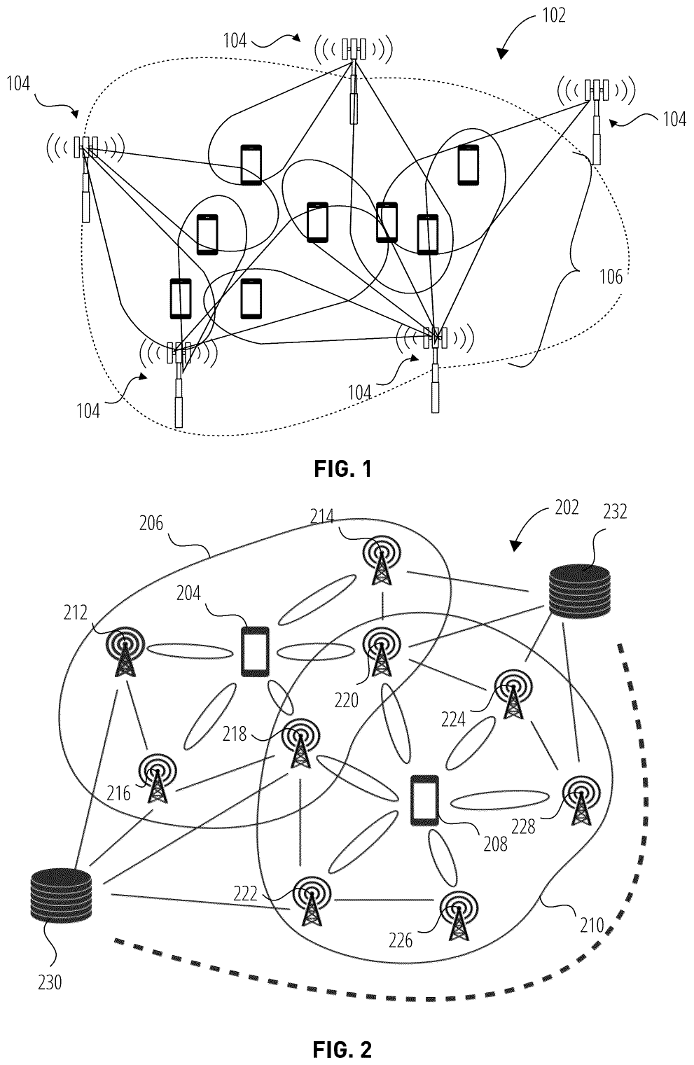

FIG. 1 illustrates a diagram 102 of a wireless communication system that operates in a cell-free manner, according to embodiments discussed herein. The diagram 102 illustrates various base stations 104 that each communicate with one or more of the UEs 106 in a cell-free manner, as described herein. As may be seen, each of the base stations 104 communicates with its respective ones of the UEs 106 without the underlying context of a formal cell as may be understood with reference to current understandings of some wireless communication systems, such as LTE and/or 5G.

Cell-free operation may imbue the wireless communication system with various potential benefits. Such benefits may include, but are not limited to: more uniform service quality for UEs (as there are no cell-edge UEs); more seamless mobility as the UEs move throughout the network (as there are no handover-related delays); and latency, throughput, and/or capacity improvements.

It is anticipated that these and other improvements of cell-free network operation may further enable the use of, for example, massive extended reality (XR) through the wireless communication system. Such improvements may result in an ability to increase a number of simultaneously supported XR users in the wireless communication system. Such improvements may allow for massive XR, immersive reality, holographic communication, etc. in wide area communication contexts.

Conceptual changes with respect to cell-based networks are implicated in cell-free networks. For example, cell-free networks may be implemented to dynamically create and maintain UE-centric clusters of base stations (rather than associating cells with a UE, as may be understood in prior systems). Further, it may be that a UE that operates in a cell-free network may support a radio resource control (RRC) connection state with the network (and not with, for example, any particular cell or base station, as may be understood in prior systems). Cell-free networks may further dynamically schedule radio resources of the cluster for use by the UE for transmission and/or reception (as opposed to cell-based scheduling, as may be understood in prior systems).

As understood herein, a cluster may be a set of base stations over which various communication functionalities (e.g., analogous to “serving cell” functionalities from previous wireless communication systems) are distributed. At each moment in time, there may be a one-to-one correspondence between a UE and its associated cluster (meaning that even a first UE and a second UE that each use the same set of base stations as a serving cluster are understood to operate according to two different logical clusters). This clustering is understood to be dynamic in nature (the individual base stations that make up a cluster serving a UE may change over time).

Note that a “cluster” may also be referred to as a “serving cluster” in some instances herein.

With respect to such clustering aspects, various proposals and work items include (but are not limited to): the definition/description of components of cell-free networks, including for the serving cluster and for a clustering control function (CCF) of the wireless communication system that implements clustering features within the wireless communication system; definition/description of parameters, triggers, and requirements for the CCF and for cluster formation and/or update operations; definition/description of rights and roles for the CCF, base stations, and UEs; definition/description for methods for initial cluster formation procedures; definition/description for methods for dynamic cluster update procedures; and/or definition/description of a mathematical model for clustering aspects within cell-free networks.

In clustering cases, a UE may support an RRC connection with the network (as opposed to an RRC connection that is understood with respect to a particular cell, as may be the case prior wireless communications systems). It may thus be that cluster updating (the removal and/or addition of base stations to the cluster serving the UE) as the UE moves through the wireless communication system may accordingly not require an RRC connection reestablishment procedure between the UE and a base station (as may be used in prior wireless communication systems).

With respect to such RRC aspects, various proposals and work items include (but are not limited to): definition/description of RRC messaging exchange guidelines and protocols for clustering operations; and/or definition/description of RRC message types used for clustering operations, including definitions, triggers, recipients, senders, and potential contents for the same within different/various modes of operation.

### Definitions

The following definitions should be (e.g., additionally) understood in the context of related descriptions for these items as found in this disclosure.

A “cell-free network architecture” or “cell-free network” incorporates/is a network that provides an adaptive (e.g., dynamic) and UE-centric distribution of various communication functionalities, such as, for example, one or more functionalities that may have been provided by a “serving cell” within prior wireless communication systems. Hence, in applicable embodiments, a serving cluster may be generally understood to operate to replace a “serving cell” as understood within prior wireless communication systems.

A “serving cluster” or “cluster” is a set of connected base stations over which various communication functionalities (e.g., conventional LTE/5G serving base station functionalities) are distributed. The connection(s) between the base stations in the set may be physical and/or logical. A cluster is defined as a one-to-one mapping with a UE. Hence, a different logical cluster exists for each UE (even when multiple UE use the same physical set of base stations). A base station can belong to one or multiple logical clusters serving different UE(s). Base stations within a same cluster that is serving a UE do not necessarily jointly perform transmit/receive operations to/from the UE. Further, control plane (CP) and user plane (UP) functionalities may be dynamically split among the base stations in the cluster serving the UE. At any given transmission time interval (TTI), a CCF within the wireless communication system controls and schedules CP and UP related data transmissions and the associated messaging for each base station in the cluster that is serving the UE.

FIG. 2 illustrates a diagram 202 showing a first UE 204 that is served by a first cluster 206 and a second UE 208 that is served by a second cluster 210, according to embodiments discussed herein. As illustrated, the first cluster 206 includes the first base station 212, the second base station 214, the third base station 216, the fourth base station 218, and the fifth base station 220. Further, as illustrated, the second cluster 210 includes the fourth base station 218, the fifth base station 220, the sixth base station 222, the seventh base station 224, the eighth base station 226, and the ninth base station 228. Note that in the example of FIG. 2, each of the fourth base station 218 and the fifth base station 220 are members of multiple different clusters that are serving different UEs (members of each of the first cluster 206 and the second cluster 210).

A “CCF” is a logical function (which may be distributed across multiple physical entities) that exists in one or more of a CN of the wireless communication system, a RAN intelligent controller (RIC) for the wireless communication system, and/or distributed across multiple base stations. A CCF of a wireless communication system dynamically controls (e.g., develops, updates, controls, and/or schedules communication through) UE-centric serving clusters. Note that herein, the clusters controlled by a single CCF may exist in one or more “connected sets” of clusters that are controlled by that CCF, where a “connected set” of clusters is a set of clusters that may be interconnected at the base station level within a geographic area corresponding to the CCF's reach. The CCF may be configured to control one or more connected sets of clusters that exist in a certain geographical area. The CCF may control its clusters/connected sets of clusters with respect to considerations such as (for example) traffic, latency, reliability, coverage, interference, sensing, mobility, base station load, radio resource management (RRM), radio link quality, backhaul ideality, location, quality of service (QoS) requirements, and/or measurement reports.

Returning to FIG. 2, note that the CCF may be capable of controlling clusters made up of base stations that communicate back to a CN of the wireless communication system through/across different CN elements and/or devices. For example, in FIG. 2, the first cluster 206, the first base station 212, the third base station 216, and the fourth base station 218 communicate with the CN through the first CN device 230 while the second base station 214 and the fifth base station 220 communicate with the CN through the second CN device 232. Further, in the second cluster 210, the fourth base station 218, the fifth base station 220, and the eighth base station 226 communicate with the CN through the first CN device 230 while the fifth base station 220, the seventh base station 224, and the ninth base station 228 communicate with the CN through the second CN device 232.

A connected base station (cBS) is a base station that is connected to a UE, and thus is operating within a cluster that is serving the UE. In other words, a cBS for a UE is a base station that is a member of/is in the cluster that is serving the UE.

An unconnected base station (uBS) is a base station (e.g., a neighboring base station) that is not connected to a UE, and thus is not operating within a cluster that is serving the UE. In other words, a uBS is a base station that is not a member of/not in the cluster that is serving the UE. In some cases, one or more uBSs may be defined by the network as a set of candidate base stations to (potentially) be added to the given UE cluster.

It will be understood that a base station's status as a cBS or uBS may be different with respect to different UEs. For example, a base station may be both a cBS with respect to a first UE/first cluster that is serving the first UE (may be in the first cluster) and a uBS with respect to a second UE/second cluster that is serving the second UE (may not be in the second cluster).

### Functionalities for Clustering in Cell-Free Multiple Input Multiple Output (MIMO)

In some wireless communication systems, a CCF has the ability to: update its connected set(s) of clusters over-the-air (OTA) by modifying, adding, or removing clusters; modify one or more clusters that it controls OTA by modifying, adding, and/or removing base station(s) within those clusters; communicate information about updated clusters to the corresponding network elements and via an appropriate interface; modify, add, and/or remove clusters by adding or removing base stations, base station-to-base station connections, and/or base station-to-UE connections within a connected cluster; keep an updated connected set of clusters over time; and/or update the connected set of clusters globally or locally in a distributed way to avoid network-wide disruptions and messaging overhead.

In some embodiments, the CCF may modify/update its connected set(s) of clusters/its clusters OTA based on one or more of: connected UE feedback and updated information on mobility, environment, measured interference, and traffic/QoS requirements; UE disconnection from a given base station in a certain cluster; UE requests/proposals of base station addition(s) or removal(s) to/from a cluster serving the UE; UE's acceptance and/or rejection of base station addition(s) or removal(s) to a cluster serving the UE; base station requests/proposals for base station addition(s) to or removal(s) from a cluster; base station acceptance and/or rejection of base station addition(s) to or removal(s) from a given cluster; new UEs connecting to a (e.g., new) cluster; and/or any combination and/or subset of these reasons.

The connected set(s) of clusters in a certain geographical area should be collectively constructed and/or formed by the CCF based on one or more of: joint communication and sensing data; environmental aspects (channel quality, channel rank, etc.); interference levels; network elements capabilities; QoS requirements; and/or a combination or subset of these aspects.

In some wireless communication systems, a CCF may have the right and/or ability to: request, globally and/or locally, other network elements (base stations and UEs) to share their current capabilities (e.g., central processing unit (CPU) loads, memory usage, supported bands, etc.) via extended RRC messaging; request, globally or locally, cBSs to share information and measurements about mobility, environment, interference, and QoS requirements of their connected UEs and/or the connected UEs of their co-located neighboring base stations via extended RRC messaging; configure, globally or locally, cBSs with coordinated synchronization signaling blocks (SSBs) that support multi-base station connectivity with a corresponding UE within a cluster that is serving the UE via extended RRC reconfiguration messaging; trigger, globally or locally, a base station addition and/or removal procedure within a given cluster (either periodically, upon UE request, and/or based on updated information and/or measurements reported by other network elements (base stations and UEs)) via extended RRC reconfiguration messaging; communicate, globally or locally, any base station addition or removal procedure outcomes to cBS(s) and/or the UE of a given cluster via extended RRC reconfiguration messaging; request, globally or locally, any base station(s) for possible addition to a given cluster via extended RRC reconfiguration messaging; accept and/or reject any addition or removal request from a UE and/or a base station with respect to a given cluster via extended RRC messaging; and request, globally or locally, base stations and/or UEs to re-initiate previously rejected base station addition or removal requests via extended RRC messaging.

In some wireless communication systems, a base station may have the right and/or ability to: request connected UEs to share their current capabilities (CPU loads, memory usage, supported bands, etc.) via extended RRC messaging; request connected UEs to share information and measurements about mobility, environment, interference, and/or QoS requirements for the cBS(s) of a given UE cluster via extended RRC messaging; request connected UEs to share information and measurements about mobility, environment, interference, and/or QoS requirements for non-connected and co-located neighboring base station(s)/uBS(s) that are not in a given UE cluster via extended RRC messaging; communicate any clustering procedure triggers and/or outcomes to a connected UE of a given cluster via extended RRC reconfiguration messaging; communicate non-contention based random access channel (RACH) configurations to a connected UE to enable base station addition to a given cluster via extended RRC reconfiguration messaging; and/or accept and/or reject any network addition request for a given cluster via extended RRC messaging.

In some wireless communication systems, a UE may have the right and/or ability to: trigger a base station addition and/or removal procedure within its own cluster (either periodically, upon request, or based on updated information and/or measurements reported by other network elements) via extended RRC reconfiguration messaging; accept and/or reject any base station addition or removal procedure outcomes with respect to its own cluster via extended RRC reconfiguration messaging; request the network to re-initiate previously rejected connectivity decision(s) via extended RRC reconfiguration messaging; accept and/or reject a network request to the UE to provide measurements about the cBS(s) of the cluster serving the UE via extended RRC messaging; accept and/or reject a network request to the UE to provide measurements about the non-connected and co-located neighboring base station(s) (uBS(s)) that are not in the cluster serving the UE via extended RRC messaging; request cBS(s) of the cluster serving the UE to share measurements about the wireless channel/environment via extended RRC messaging; share the measurements of the wireless channel/environment for the non-connected and co-located neighboring base station(s) (uBS(s)) that are not in the cluster serving the UE to the network via extended RRC messaging; and/or accept and/or reject a network decision to add a carrier and/or RAT via extended RRC messaging.

Embodiments with Respect to Messaging

As understood herein, one or more uBSs may be defined by the network as a set of candidate base stations to be added to a given UE cluster. In various embodiments, a UE is able to perform measurements for both uBSs and its cBSs. Further, the CCF is able to either directly or indirectly exchange messages with all base stations via proper interface(s). Further both uBSs and cBSs are able to exchange messages using, for example, Xn interfaces.

With this contextual background, eight types of messages are defined as between the CCF, cBSs, uBSs, and UEs. These messages may be used to coordinate, communicate, and process clustering procedures as described herein as between these entities.

With respect to discussion herein, each of the eight different message types may be differentiated from the other seven message types by, among other aspects, reference to the sender and receiver(s) of such a message. Further, it will be understood that a first message type and a second message type may have similar/analogous information therein (such as, for example, the case where a first message type is used for communication of information between a CCF and a base station and a second message type is used for communication of that same/analogous information between the base station and a UE.

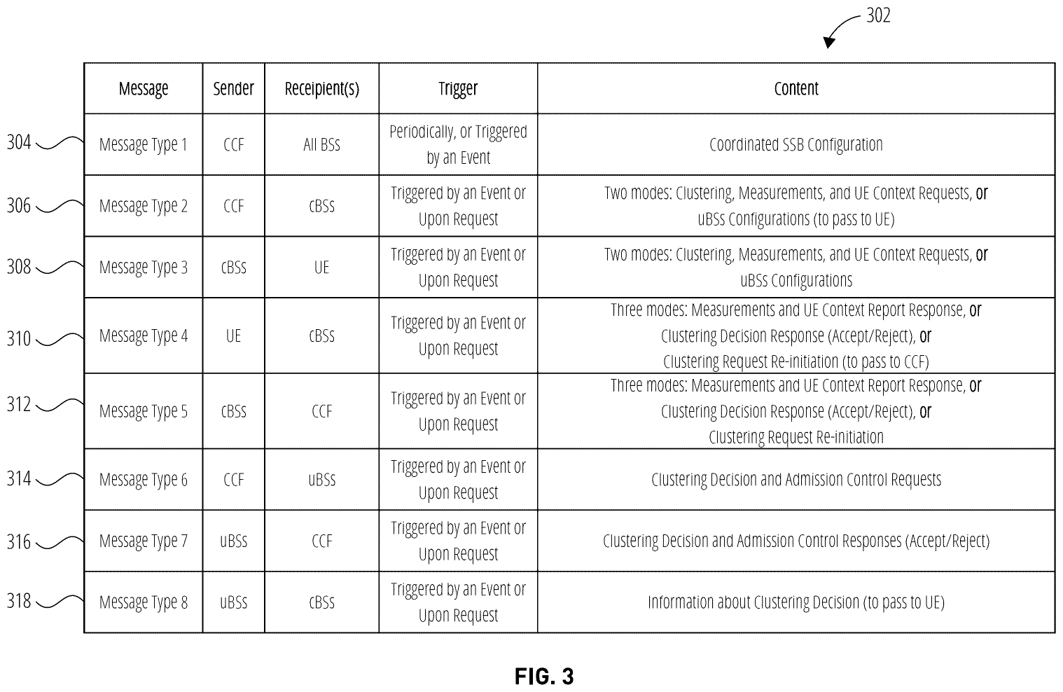

FIG. 3 illustrates a table 302 of various message types that may be used in a wireless communication system implementing cell-free, cluster-based operations as described herein.

### Message Type 1

Messages of the first message type 304 are used by the CCF to send coordinated SSB configurations to all base stations which potentially can work together within a cluster to coordinate their SSBs in order to facilitate UE SSB searches using those SSBs. In some cases, a message of the first message type 304 can be triggered based on a pre-configured periodicity. In some cases, this message can be triggered based on a pre-configured event. For example, a change of a UE state (a change in a mobility state, a UE base station addition/removal request, a change in channel conditions, etc.) and/or the joining of a new UE to the wireless communication system may trigger the message of the first message type 304.

A message of the first message type 304 is sent to all the base stations connected to the CCF, which potentially may work together in a cluster or clusters.

A message of the first message type 304 may include time and/or frequency multiplexed/coordinated SSB burst configuration information to support multi-base-station search.

A message of the first message type 304 may include coordinated primary synchronization signal (PSS) and secondary synchronization signal (SSS) configuration information to support multi-base-station synchronization.

A message of the first message type 304 may include coordinated master information block (MIB) configuration information to provide multi-base-station and/or multi-band support. This coordinated MIB configuration information may include/indicate: support for different MIB periodicities (e.g., including but not limited to 80 milliseconds (ms)) to support coordinated/multiplexed SSB bursts (collision avoidance can be used); support for multiple frame number (SFNs) for each base station; support for multiple numerologies for multi-band operation; support for multi-base-station/multi-band system information block (SIB) 1 (SIB1) configurations (where different CORESETs may have support for multi-base-station operation); and/or support for multi-base-station/multi-band physical broadcast channel (PBCH)-demodulation reference signal (DMRS) configurations.

A message of the first message type 304 may include coordinated SIB1 configuration information to provide multi-base-station support. This coordinated SIB1 configuration information may include/indicate: support of different SIB1 periodicities (e.g., including, but not limited to, 160 ms) to support coordinated/multiplexed SSB bursts (collision avoidance can be used); support of different RACH configuration and resource allocation for each base station; support of different CORESET configurations for multi-base-station operation; support of different base station selection information (e.g., a minimum received signal strength indicator (RSSI) level) for multi-base-station operation.

### Message Types 2 and 3

Messages of the second message type 306 and the third message type 308 allow the CCF to send information to a UE via the UE's cBS(s). In some cases, the CCF sends the cBS(s) a message of the second message type 306 and the cBS(s) send a message of the third message type 308 having analogous information to that of the second message type 306 to a UE. It is also contemplated that the second message type 306 and/or the third message type 308 may be used individually/in other situations in some cases.

As illustrated in FIG. 3, messages of the second message type 306 and the third message type 308 may operate in one of two different modes. A first such mode (“Mode 1”) may be a “Pre-Clustering Decision Request Mode” that is for the communication of requests between the CCF and a UE prior to a clustering decision by the CCF. Messages of the second message type 306 and the third message type 308 under Mode 1 may include, for example, a clustering request and/or a measurements request, which may include, for example, one or more of a request for base station or removal, a request for measurements/a measurement report (e.g., as is described in more detail later herein), and/or a UE context report.

A second such mode (“Mode 2”) may be a “Clustering Decision Request Mode” that is for the configuration of the neighboring and non-connected base stations (uBSs) (e.g., that are defined/understood as a set of candidate base stations to be added to a cluster that is serving the UE).

In some embodiments, the use of the second message type 306 and the third message type 308 as described may be triggered based on a pre-configured event. For example, a change of a UE state (e.g., a mobility state of the UE, channel conditions for the UE, etc.), a CCF base station addition and/or removal request, and/or the joining of a new UE to the wireless communication system may trigger the use of the second message type 306 and the third message type 308.

In some embodiments, the use of the second message type 306 and the third message type 308 as described may be triggered based on a pre-configured request. For example, a UE request of a base station addition or removal from its own cluster may trigger the use of the second message type 306 and third message type 308.

Content found in messages of the second message type 306 and/or the third message type 308 may include various information items. For example, in at least some embodiments, messages of the second message type 306 and/or the third message type 308 include a mode selection identifier that identifies whether the message is operating according to Mode 1 or Mode 2 (e.g., as described herein).

As another example, in at least some embodiments, messages of the second message type 306 and/or the third message type 308 include a request identifier (ID) that the UE and/or the CCF can use to correlate the requests of these messages with corresponding/responsive measurements/measurement reports and/or UE context report messages.

As another example, in at least some embodiments, Mode 1 messages of the second message type 306 and/or the third message type 308 may include measurement targeting object information that specifies measurement objects (e.g., radio reference signals or channels) that the UE should measure. This measurement targeting object information may also specify which neighboring and non-connected base stations (uBSs) are to be measured by the UE.

As another example, in at least some embodiments, Mode 1 messages of the second message type 306 and/or the third message type 308 may include measurement time configuration information that specifies a timing of the requested measurement reports.

As another example, in at least some embodiments, Mode 1 messages of the second message type 306 and/or the third message type 308 may include measurement report configurations that specify a format for the requested measurement reports (e.g., that is expected by the CCF).

As another example, in at least some embodiments, Mode 1 messages of the second message type 306 and/or the third message type 308 may include UE context request configuration information that specifies a format of and/or contents of a requested UE context report. Example contents of such a UE context report that may be requested may include, for example, a UE RRM configuration (with UE inactive times), a QoS flow to data radio bearer (DRB) mapping, information with respect to UE capabilities for different RATs, and/or protocol data unit (PDU) session and/or network slice information.

As another example, in at least some embodiments, Mode 2 messages of the second message type 306 and/or the third message type 308 may include a cluster ID associated with the cluster that is serving the UE in question.

As another example, in at least some embodiments, Mode 2 messages of the second message type 306 and/or the third message type 308 may include dedicated RACH, MIB, SIB1, and/or time/frequency configuration information for the selected neighboring and non-connected base stations (uBSs) that are to be connected to a given cluster that is serving a UE.

### Message Types 4 and 5

Messages of the fourth message type 310 and the fifth message type 312 allow a UE to send information to the CCF via its cBS(s). In some cases, the UE sends the cBS(s) a message of the fourth message type 310 and the cBS(s) send a message of the fifth message type 312 having analogous information to that of the fourth message type 310 to the CCF. It is also contemplated that the fourth message type 310 and/or the fifth message type 312 may be used individually/in other situations in some cases.

As illustrated in FIG. 3, messages of the fourth message type 310 and the fifth message type 312 may operate in one of three different modes. A first such mode (“Mode 1”) may be a “Pre-Clustering Response Mode” that is for responding to Mode 1 messages of the second message type 306 and/or the third message type 308 (e.g., to either accept or reject these Mode 1 messages, potentially with information indicating a reasoning for doing so).

A second such mode (“Mode 2”) may be a “Clustering Decision Response Mode” that is for responding to Mode 2 of messages of the second message type 306 and/or the third message type 308 (e.g., to either accept or reject these Mode 2 messages, potentially with information indicating a reasoning for doing so).

A third such mode (“Mode 3”) may be a “Clustering Re-initiation Request Mode” that is used by the UE to request to re-initiate a previously rejected pre-clustering and/or clustering decision request from the CCF. In response to these Mode 3 messages, the CCF may re-send previous messages of the second message type 306 and the third message type 308 to trigger the UE to send measurements and/or a UE context report for a (potential) clustering update.

In some embodiments, the use of the fourth message type 310 and the fifth message type 312 as described may be triggered based on a pre-configured event. For example, a change of a UE state (e.g., a mobility state of the UE, channel conditions for the UE, etc.) and/or a CCF base station addition and/or removal request may trigger the use of the fourth message type 310 and the fifth message type 312.

In some embodiments, the use of the fourth message type 310 and the fifth message type 312 as described may be triggered based on a pre-configured request. For example, a UE request to re-initiate a previously rejected base station addition or removal request to/from its cluster by CCF may trigger the use of the fourth message type 310 and the fifth message type 312.

Content found in messages of the fourth message type 310 and/or the fifth message type 312 may include various information items. For example, in at least some embodiments, messages of the fourth message type 310 and/or the fifth message type 312 include a mode selection identifier that identifies whether the message is operating according to Mode 1, Mode 2, or Mode 3 (e.g., as described herein).

As another example, in at least some embodiments, messages of the fourth message type 310 and/or the fifth message type 312 include a request ID that the UE and/or the CCF can use to correlate a request (e.g., per the second message type 306 and the third message type 308) with corresponding/responsive measurement and/or UE context report information (as found in these messages of the fourth message type 310 and the fifth message type 312).

As another example, in at least some embodiments, Mode 1 messages of the fourth message type 310 and/or the fifth message type 312 may include a response (e.g., a binary response) that indicates whether the UE accepts or rejects a pre-clustering report request (e.g., for measurements and/or UE context information) of messages of the second message type 306 and the third message type 308 that operate according to a Mode 1 (as described herein). The Mode 1 messages of the fourth message type 310 and the fifth message type 312 may further indicate a reasoning for the acceptance and/or rejection. With respect to rejection, may indicate a lack of memory, a high CPU load, insufficient resources, etc. With respect to acceptance, this may indicate that the UE will respond substantively to the pre-clustering report request.

As another example, in at least some embodiments, Mode 1 messages of the fourth message type 310 and/or the fifth message type 312 may include measurement reports (e.g., in response to a request for the same as found in a second message type 306 and/or a third message type 308, as is described herein. These measurement reports may format for the requested measurement reports that was previously specified and/or correspond to a timing that was previously specified in the second message type 306 and/or the third message type 308, as these are discussed herein.

As another example, in at least some embodiments, Mode 1 messages of the fourth message type 310 and/or the fifth message type 312 may include UE context information. This UE context information may include one or more of: a UE RRC status, a UE RRM configuration (with UE inactive times), a QoS flow to DRB mapping, information with respect to UE capabilities for different RATs, a radio link control (RLC) buffer status report for the UE (during active times), and/or PDU session and/or network slice information.

As another example, in at least some embodiments, Mode 2 messages of the fourth message type 310 and/or the fifth message type 312 may include a response (e.g., a binary response) that indicates whether the UE accepts or rejects a clustering decision request of messages of the second message type 306 and the third message type 308 that operate according to a Mode 2 (as described herein). The Mode 2 messages of the fourth message type 310 and the fifth message type 312 may further indicate a reasoning for the acceptance and/or rejection. With respect to rejection, may indicate a lack of memory, a high CPU load, insufficient resources, etc. With respect to acceptance, this may indicate that the UE accepts the request to connect to a uBS and/or disconnect from a cBS as has been requested by the system, as the case may be. Mode 2 messages of the fourth message type 310 and the fifth message type 312 may be associated with/to a cluster ID for the cluster serving the UE.

As another example, in at least some embodiments, Mode 3 messages of the fourth message type 310 and/or the fifth message type 312 may include a UE request for the CCF to re-initiate a previously rejected pre-clustering request (corresponding to Mode 1 messages of the second message type 306 and the third message type 308) and/or a previously rejected clustering decision request (corresponding to Mode 2 messages of the second message type 306 and the third message type 308) from the CCF. Such Mode 3 messages of the fourth message type 310 and the fifth message type 312 may contain a request ID of the messages of the second message type 306 and the third message type 308 that correspond to the prior request that is desired by the UE to be re-initiated. In response to its receipt of these Mode 3 messages of the fourth message type 310 and the fifth message type 312, the CCF may resend a message of the second message type 306 to a cBS (to which the cBS responds by sending a message of the third message type 308 to a UE) corresponding to the specified request ID in order to trigger/cause the UE to (potentially) send measurements and/or a UE context report for clustering update purposes.

### Message Type 6

Messages of the sixth message type 314 are used by the CCF to request neighboring and non-connected base stations (uBSs) that do not belong to a cluster serving a UE, with respect to a given clustering decision request that involves the uBSs, to perform admission control procedures in order to check if that uBS is available to join that UE cluster.

In some embodiments, the use of the sixth message type 314 as described may be triggered based on a pre-configured event. For example, a change of a UE state (e.g., a mobility state of the UE, channel conditions for the UE, etc.), a CCF base station addition and/or removal request, and/or the joining of a new UE to the wireless communication system may trigger the use of the sixth message type 314.

In some embodiments, the use of the sixth message type 314 as described may be triggered based on a pre-configured request. For example, a UE request of a base station addition or removal from its own cluster may trigger the use of the sixth message type 314.

A message of the sixth message type 314 may be sent from the CCF to uBSs that are defined/understood as a set of candidate base stations for purposes of addition to the UE cluster.

Content found in messages of the sixth message type 314 may include various information items. For example, in at least some embodiments, messages of the sixth message type 314 include a request ID that the CCF and the receiving uBS(s) can use to identify the admission control procedure request.

As another example, in at least some embodiments, messages of the sixth message type 314 include a cluster ID associated with the cluster that is serving the UE in question.

As another example, in at least some embodiments, messages of the sixth message type 314 include UE context information. This UE context information may include one or more of: a UE RRC status, a UE RRM configuration (with UE inactive times), a QoS flow to DRB mapping, information with respect to UE capabilities for different RATs, an RLC buffer status report for the UE (during active times), and/or PDU session and/or network slice information.

### Message Type 7

Messages of the seventh message type 316 are used by a uBS to respond to a CCF's admission control request with respect to a given clustering decision request that involves the uBS.

In some embodiments, the use of the seventh message type 316 as described may be triggered based on a pre-configured event. For example, a change of a UE state (e.g., a mobility state of the UE, channel conditions for the UE, etc.), a CCF base station addition and/or removal request, and/or the joining of a new UE to the wireless communication system may trigger the use of the seventh message type 316.

In some embodiments, the use of the seventh message type 316 as described may be triggered based on a pre-configured request. For example, a UE request of a base station addition or removal from its own cluster may trigger the use of the seventh message type 316.

Content found in messages of the seventh message type 316 may include various information items. For example, in at least some embodiments, messages of the seventh message type 316 include a request ID that the uBS and the CCF can use to identify the admission control procedure request.

As another example, in at least some embodiments, messages of the seventh message type 316 may include a cluster ID associated with the cluster that is serving the UE in question.

As another example, in at least some embodiments, messages of the seventh message type 316 may include a response (e.g., a binary response) that indicates whether the UE accepts or rejects a clustering and admission control request of messages of the sixth message type 314. In such circumstances, messages of the seventh message type 316 may further indicate a reasoning for the acceptance and/or rejection. With respect to rejection, the message may indicate an unsupported network slice, a lack of memory, a high CPU load, insufficient resources, etc. With respect to acceptance, such an acceptance may serve as an indication to the CCF that the uBS will attempt to join the cluster that is serving the UE/attempt to connect to the UE. Such messages of the seventh message type 316 may be associated with/to a cluster ID for the cluster serving the UE.

### Eighth Message Type

Messages of the eighth message type 318 are used by neighboring and the non-connected base stations (uBSs) of a UE, with respect to a given clustering decision request that involves uBSs, to send dedicated configuration information (e.g., dedicated RACH and/or SIB1 configuration information) for connecting to the uBS to cBS(s) of the UE in question (such that those cBS(s) may then provide that information to the UE).

In some embodiments, the use of the eighth message type 318 as described may be triggered based on a pre-configured event. For example, a change of a UE state (e.g., a mobility state of the UE, channel conditions for the UE, etc.), a CCF base station addition and/or removal request, and/or the joining of a new UE to the wireless communication system may trigger the use of the eighth message type 318.

In some embodiments, the use of the eighth message type 318 as described may be triggered based on a pre-configured request. For example, a UE request of a base station addition or removal from its own cluster may trigger the use of the eighth message type 318.

A message of the eighth message type 318 may be sent to one or more of the cBS(s) for the UE that are in the cluster that is serving the UE.

Content found in messages of the eighth message type 318 may include various information items. For example, in at least some embodiments, messages of the eighth message type 318 include a cluster ID associated with the cluster that is serving the UE in question.

As another example, in at least some embodiments, messages of the eighth message type 318 include dedicated RACH, MIB, SIB1, and/or time/frequency configuration/synchronization information for the uBSs that are to be connected to a given cluster that is serving a UE.

As another example, in at least some embodiments, messages of the eighth message type 318 includes a request ID that the uBS and the CCF can use to identify the admission control procedure request.

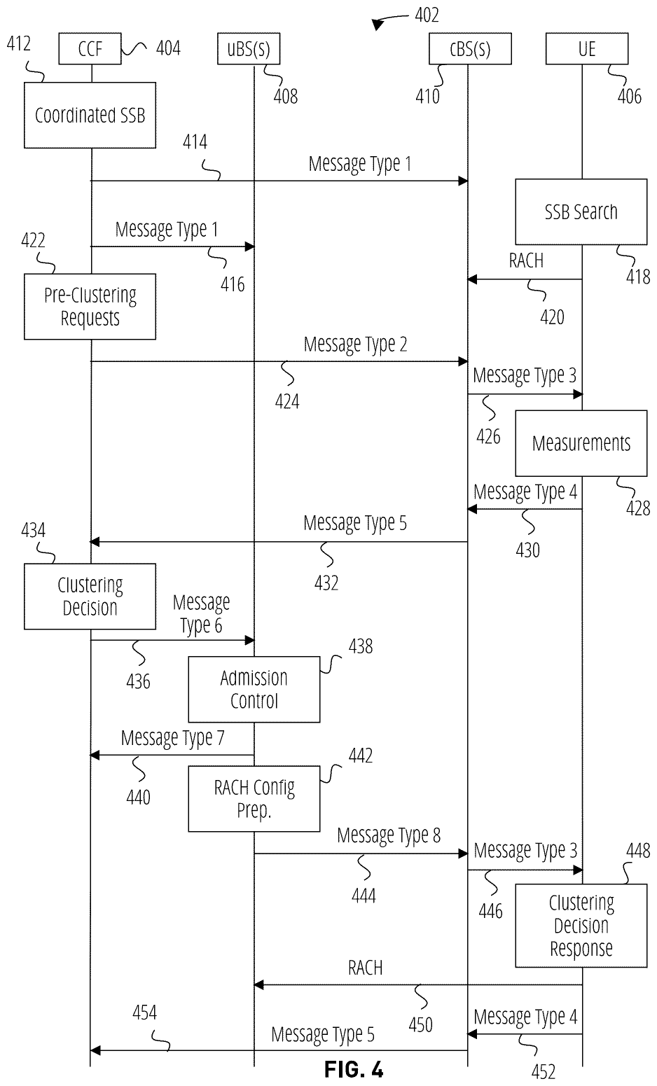

FIG. 4 illustrates a flow diagram 402 for a messaging exchange for a clustering decision controlled by a CCF 404 with respect to a UE 406, according to embodiments discussed herein. The flow diagram 402 illustrates communications that occur as between the CCF 404, one or more uBS(s) 408 that are not part of a cluster serving the UE 406, one or more cBS(s) 410 that are in a cluster serving the UE 406, and the UE 406. Note that at initial junctures within the discussion of FIG. 4, one or more of the cBS(s) 410 under discussion should be understood prospectively (as will be apparent from the contextual usage).

As illustrated, the CCF 404 may first operate according to a coordinated SSB phase 412. During the coordinated SSB phase 412, the CCF 404 sends message(s) of the first message type 304 to various base stations (e.g., sends 414 messages of the first message type 304 to the cBS(s) 410 of the UE and sends 416 messages of the first message type 304 to the uBS(s) 408). Note that at this juncture, the UE 406 may not yet be connected to any of the cBS(s) 410). Information found in the messages of the first message type 304 may be used by the receiving base stations to configure particular SSB(s) at each such base station, such that the overall use of SSBs across all the base stations are coordinated in time, frequency, and/or direction. This organization may facilitate effective SSB searches (e.g., as performed by the UE 406) across the portion of the RAN corresponding to these base stations.

The UE 406 may first operate according to an SSB search phase 418. During the SSB search phase 418, the UE may search the SSBs being broadcast by the base stations and, based on its receipt of an appropriate SSB from a base station, performs a RACH procedure 420 with that base station. At this juncture, the connected-to base station is understood as one (e.g., a first-in-time) of the cBS(s) 410 of a cluster that is serving the UE as represented in FIG. 4.

Once the UE 406 has established a connection to the cBS(s) 410 (e.g., which at least is achieved through the connection to a first-in-time cBS as has been described herein in relation to the operations of the coordinated SSB phase 412 and the SSB search phase 418), the CCF 404 is enabled to modify the cluster by adding or removing base stations within the cluster for the UE (e.g., to modify the cBS(s) 410).

To this end, the CCF 404 may operate according to a pre-clustering request phase 422. The CCF 404 sends 424 a message of the second message type 306 to the cBS(s) 410. In response, the cBS(s) 410 send 426 a message of the third message type 308 to the UE 406. Consistent with discussion herein, these messages may include, for example, a request of the UE to provide a measurement report having measurements of one or more measurement objects corresponding to one or more of the uBS(s) 408.

In response to the receipt of the message of the third message type 308 from the cBS(s) 410, the UE 406 may perform the requested measurements 428.

The UE 406 then sends 430 a message of the fourth message type 310 to the cBS(s) 410. In response, the cBS(s) 410 send 432 a message of the fifth message type 312 to the CCF. Consistent with discussion herein, these messages may include, for example, a measurement report comprising the measurements 428 of the one or more measurement objects corresponding to the uBS(s) 408, as previously requested by the CCF 404.

Once the measurement report is received at the CCF 404, the CCF 404 may operate according to a clustering decision phase 434. Based on the measurement report, the CCF 404 identifies one(s) of the uBS(s) 408 that it would like to add to the cluster that is serving the UE.

The CCF 404 sends 436 a message of the sixth message type 314 to these uBS(s) 408. Consistent with discussion here, this message may include, for example, a request for the receiving uBS(s) to perform admission control procedures to determine whether that uBS is available to join the cluster that is serving the UE 406.

The uBS(s) 408 that receive this message may correspondingly perform admission control procedures 438 to determine whether they are available to join the cluster that is serving the UE 406.

Then, as illustrated, one or more of the uBS(s) 408 that ultimately determine that they are available to join the cluster that is serving the UE 406 send 440 a message of the seventh message type 316 to the CCF. Consistent with discussion here, this message may include, for example, an indication that the sending uBS can/will attempt to join the cluster serving the UE.

Further, these one(s) of the uBS(s) 408 that have determined that they are available to join the cluster that is serving the UE 406 prepare 442 RACH configuration(s) for the UE 406 to use to connect to these uBSs.

These uBS(s) 408 then send 444 message(s) of the eighth message type 318 to cBS(s) 410 for the UE 406. Consistent with disclosure herein, these message(s) may include the RACH configuration(s) for the UE 406 to use to connect to the corresponding uBS(s) 408.

The cBS(s) 410 then send 446 message(s) of the third message type 308 to the UE 406. Consistent with disclosure herein, these message(s) may include the RACH configuration(s) for the UE 406 to use to connect to the uBS(s) 408 corresponding to the RACH configuration(s) (e.g., as these were received from the messages(s) of the eighth message type 318).

Based on its receipt of these message(s), the UE 406 formulates 448 a clustering decision response. As illustrated, the UE may initiate 450 one or more RACH procedures with one or more of the uBS(s) 408 based on the received RACH configurations, in order to connect to those ones of the uBS(s) 408 and bring them into the cluster that is serving the UE as cBS(s) 410.

Further, the UE may send 452 a message of the fourth message type 310 to the cBS(s) 410. Consistent with discussion herein, this message may include an indication the UE 406 accepts the clustering decision request to connect to the applicable ones of the uBS(s) 408, as has been described.

Finally, the cBS(s) 410 may send 454 a message of the fifth message type 312 to the CCF 404. Consistent with disclosure herein, this message may include the indication the UE 406 accepts the clustering decision request to connect to the applicable ones of the uBS(s) 408, as has been described.

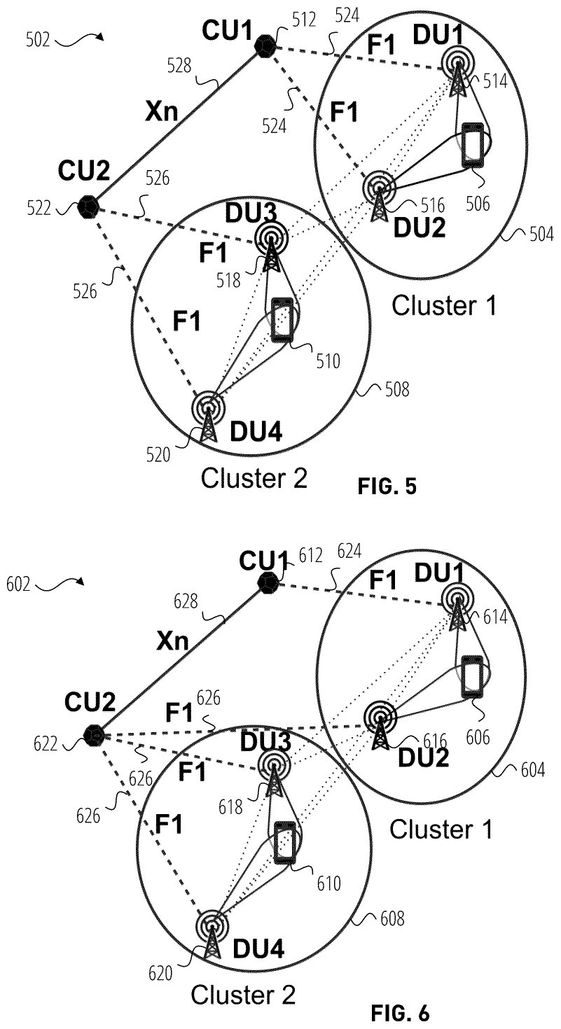

FIG. 5 through FIG. 10 illustrate various arrangements of clusters that are possible within a wireless communication network having base stations that implement a centralized unit (CU)/distributed unit (DU) split. In some wireless communication systems, a base station functionality may be split between CU and one or more DUs, where the CU acts to control the one or more DUs and connect them back to the CN, while the one or more DUs act to provide physical level radio resources of the RAN as controlled by the CN.

It will be understood that the concepts, systems, and methods with respect to clustering that are described expressly herein with respect to individual base stations of a cluster could be applied instead at the level of an individual DUs of a base station (e.g., as controlled by a CU), when applicable (e.g., when one or more base stations operate using a CU/DU split architecture, as illustrated in FIG. 5 through FIG. 10).

FIG. 5 illustrates a first example arrangement 502 of clusters that is possible within a wireless communication system having base stations that implement a CU/DU split. A first cluster 504 serves a first UE 506, while a second cluster 508 serves a second UE 510. The first cluster 504 is made up of a first DU 514 and a second DU 516 that are each controlled by a first CU 512 via first F1 interfaces 524 stemming from the first CU 512. The second cluster 508 is made up of a third DU 518 and the fourth DU 520 that are controlled by a second CU 522 via second F1 interfaces 526 stemming from the second CU 522. The first CU 512 and the second CU 522 communicate using an Xn interface 528.

FIG. 6 illustrates a second example arrangement 602 of clusters that is possible within a wireless communication system having base stations that implement a CU/DU split. A first cluster 604 serves a first UE 606, while a second cluster 608 serves a second UE 610. The first cluster 604 is made up of a first DU 614 and a second DU 616, where the first DU 614 is controlled by a first CU 612 via a first F1 interface 624 stemming from the first CU 612 and the second DU 616 is controlled by a second CU 622 via one of the second F1 interfaces 626 stemming from the second CU 622. The second cluster 608 is made up of a third DU 618 and the fourth DU 620 that are controlled by the second CU 622 via two of the second F1 interfaces 626 stemming from the second CU 622. The first CU 612 and the second CU 622 communicate using an Xn interface 628.

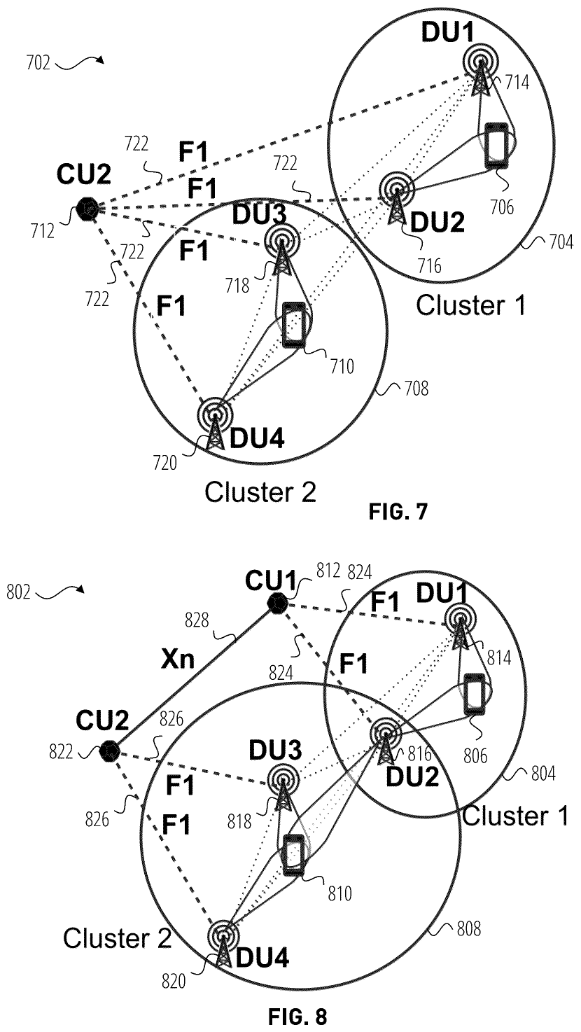

FIG. 7 illustrates a third example arrangement 702 of clusters that is possible within a wireless communication system having base stations that implement a CU/DU split. A first cluster 704 serves a first UE 706, while a second cluster 708 serves a second UE 710. The first cluster 704 is made up of a first DU 714 and a second DU 716, where the first DU 714 and the second DU 716 are each controlled by a CU 712 via F1 interfaces 722 stemming from the CU 712. The second cluster 708 is made up of a third DU 718 and the fourth DU 720 that are (also) controlled by the CU 712 via F1 interfaces 722 stemming from the CU 712.

FIG. 8 illustrates a fourth example arrangement 802 of clusters that is possible within a wireless communication system having base stations that implement a CU/DU split. A first cluster 804 serves a first UE 806, while a second cluster 808 serves a second UE 810. The first cluster 804 is made up of a first DU 814 and a second DU 816 that are each controlled by a first CU 812 via first F1 interfaces 824 stemming from the first CU 512. The second cluster 808 is made up of the second DU 816, a third DU 818, and a fourth DU 820. The second DU 816 is controlled by the first CU 812 via one of the first F1 interfaces 824 stemming from the first CU 812 (as previously mentioned), and the third DU 818 and the fourth DU 820 are controlled by the second CU 822 via second F1 interfaces 826 stemming from the second CU 522. The first CU 812 and the second CU 822 communicate using an Xn interface 828.

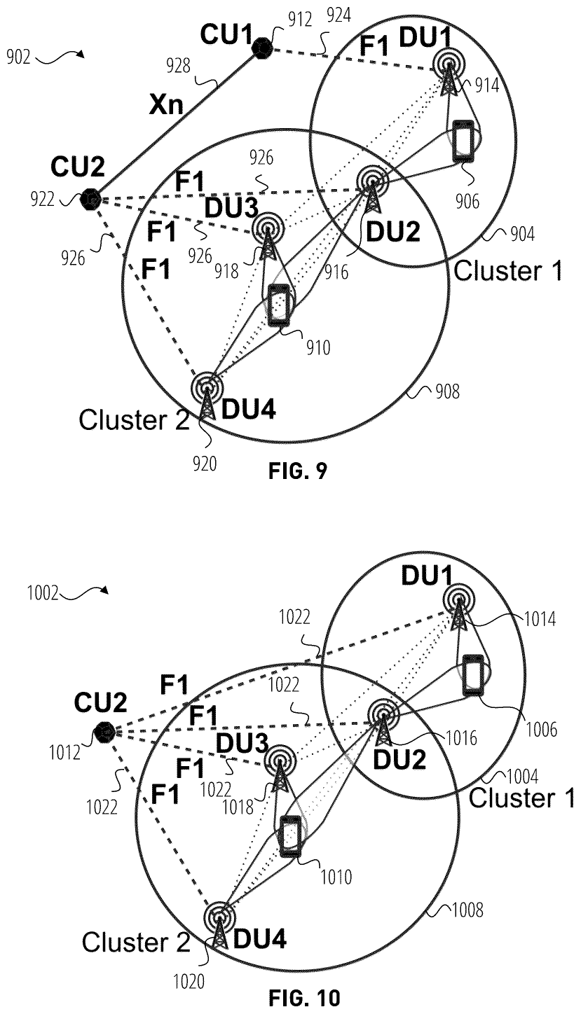

FIG. 9 illustrates a fifth example arrangement 902 of clusters that is possible within a wireless communication system having base stations that implement a CU/DU split. A first cluster 904 serves a first UE 906, while a second cluster 908 serves a second UE 910. The first cluster 904 is made up of a first DU 914 and a second DU 916, where the first DU 914 is controlled by a first CU 912 via a first F1 interface 924 stemming from the first CU 912 and the second DU 916 is controlled by a second CU 922 via one of the second F1 interfaces 926 stemming from the second CU 922. The second cluster 908 is made up of the second DU 916, a third DU 918, and a fourth DU 920, each of which are controlled by the second CU 922 via the second F1 interfaces 926 stemming from the second CU 922. The first CU 912 and the second CU 922 communicate using an Xn interface 928.

FIG. 10 illustrates a sixth example arrangement 1002 of clusters that is possible within a wireless communication system having base stations that implement a CU/DU split. A first cluster 1004 serves a first UE 1006, while a second cluster 1008 serves a second UE 1010. The first cluster 1004 is made up of a first DU 1014 and a second DU 1016, where the first DU 1014 and the second DU 1016 are each controlled by a CU 1012 via F1 interfaces 1022 stemming from the CU 1012. The second cluster 708 is made up of the second DU 1016, a third DU 1018, and a fourth DU 1020 that are (also) controlled by the CU 1012 via F1 interfaces 1022 stemming from the CU 1012.

Various definitions are now provided for consideration within an area corresponding to a CCF (e.g., within a given metropolitan area with common distributed entity that hosts a CCF function):
S is a set of m active base stations. S may be defined/understood as S:={sₖ: k=1, . . . , m}.
U is a set of n active UEs. U may be defined/understood as U: {uᵢ: i=1, . . . , n}, where n>>m.
C is a set of n clusters in connected sets of clusters that correspond to n active UEs. C may be defined/understood as C:={C(u): u∈U}.

With respect to aspects corresponding to C, it may be understood that:
C(u) is a set of active base stations serving the UE u in a cluster. C(u) may be defined/understood as C(u)⊆S.
C′(u) is a combination of current cluster C(u) and the candidate base station s. Within this framework, it will be accordingly understood that |C′(u)|=|C(u)|+1. C′(u) itself may be defined/understood as C′(u):=C(u|C(u), s):={s′: s′∈C(u)∪s, C(u)⊆S, s′∈S}.
   |C| is a number of clusters in connected sets of clusters (accordingly, |C|=n).
   |C(u)| is a number of base stations in the cluster of the UE u (which may depend on a UE's capabilities and/or an output of a CCF clustering algorithm). It will be understood that |C(u)|≤m.
   |C(s)| is a number of clusters that include a base station s.

Continuing with further definitions, it may be provided that:
P: S×U→ [symbol] _{≥0}, where P is a measured reference signal received power (RSRP) (for example) between all UEs and base stations defined as P:={P(s,u): s∈S, u∈U}.
α=α_{Traf}·α_{MU}, where a is an inference factor that, as shown, is based on a traffic sparsity factor α_{Traf} and a multi-user MIMO (MU-MIMO) multiplexing factor α_{MU}, each of which may contribute into a carrier load factor.
β=β_{Traf}·β_{MU}, where β, as shown, is based on a traffic sparsity factor β_{Traf} and an MU-MIMO multiplexing factor β_{MU}, each of which may contribute into carrier load factor.

$$res ( s \vert C ) := \frac{BW}{β \cdot \vert C ( s ) \vert} ,$$

where res(s|C) is an average amount of radio resources that base station s can provide to a cluster/to a UE.

It may be assumed that a scheduler assigns resources for joint transmission/reception when available. Thus, for a particular UE u corresponding to the cluster C(u), the elements of C(u) may be ordered in the increasing order of res, defined as res(s₁(u)|C)≤ . . . ≤res(s_{K}(u)|C), K:=|C(u)|. Further, it may be understood that res(s₁(u)|C) resources will be allocated for joint transmission/reception from all the base stations from C(u). Finally, rₖ(u|C):=res(sₖ(u)|C)−res(sₖ₋₁(u)|C) may represent the common amount of radio resources that a subset Cₖ(u) would joint use for joint transmit/receive to UE u, where Cₖ(u):={sᵢ: i>k, sᵢ∈C(u)}.

A description of uses of target functions within the mathematical framework/context will now be provided. A target function for a UE u assuming that a candidate base station s is added/removed to/from a current active cluster C(u) may be denoted E(u|C(u)∪s), E(u|C(u)\s) (as the case may be).

With respect to the addition of candidate base station s, the corresponding target function may be understood as:

$$E ( u \vert C ( u ) ⋃ s ) = E ( u \vert C ( u ) ) + G ( u \vert C ( u ) , s ) - F ( C \vert C ( u ) , s , u )$$

where:
E(u|C(u)) is a target function value for the current cluster C(u) for UE u;
G(u|C(u), s) is the target function gain for the target function for the UE u due to the (potential) connection between UE u and the candidate base station s, and
F(C|C(u), s, u) is the network-wide penalty due to the (potential) connection between UE u and the candidate base station s.

E(u|C(u)) may represent spectral efficiency at UE u assuming joint transmission or receptions by base stations in C(u), and may be calculated using:

$$E ( u \vert C ( u ) ) = {\sum }_{k} {r}_{k} ( u \vert C ) log ( 1 + \frac{{\sum }_{{s}^{′} ∈ {C}_{k} ( u )} P ( {s}^{′} , u )}{{σ}_{N}^{2} + α {\sum }_{{s}^{′} ∉ {C}_{k} ( u ) , {s}^{′} ∈ {S}^{P ( {s}^{′} , u )}}} ) .$$

G(u|C(u),s) may represent spectral efficiency improvement at the UE u due to interference to noise ratio (INR) gain, and may be calculated using:

$$G ( u \vert C ( u ) , s ) \approx log ( \frac{{\prod }_{{k}^{′}} {( 1 + \frac{α}{{σ}_{N}^{2}} {\sum }_{{s}^{′} ∉ {C}_{{k}^{′}}^{′} ( u ) , {s}^{′} ∈ {S}^{P ( {s}^{′} , u )}} )}^{{r}_{{k}^{′}} ( u )}}{{\prod }_{k} {( 1 + \frac{α}{{σ}_{N}^{2}} {\sum }_{{s}^{′} ∉ {C}_{k} ( u ) , {s}^{′} ∈ {S}^{P ( {s}^{′} , u )}} )}^{{r}_{k} ( u )}} ) .$$

Accordingly, it will be understood that within this framework, the overall network target to be optimized is, in some embodiments:

$${\prod }_{u ∈ U} E ( u \vert C ( u ) ) \to {max}_{C} .$$

### Initial Clustering Methods

Methods for performing initial clustering (establishing a new cluster for a UE, for example in the case that a UE has only recently attached to the network through a RACH procedure with a first base station) are now discussed.

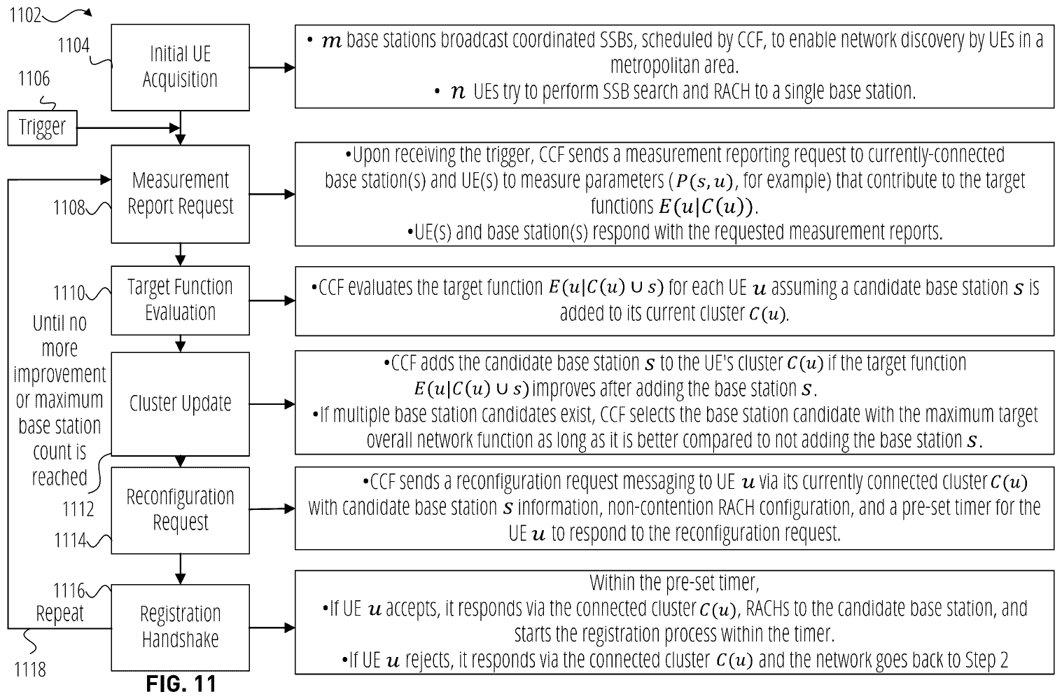

In a first method for initial clustering, a greedy algorithm may be implemented. FIG. 11 illustrates a method 1102 of a greedy algorithm for performing initial clustering, according to embodiments discussed herein. The method 1102 is described here using the context of a mathematical framework used for target functions, as such a framework is presented herein.

As illustrated, the method 1102 includes initial UE acquisition 1104. During the initial UE acquisition 1104, m base stations broadcast coordinated SSBs as scheduled/configured by the CCF, which allows for UE discovery (e.g., in the applicable metropolitan area). It may be that n UEs are attempting to perform SSB search and connect to the network via a RACH procedure with a single base station.

The remainder of the method 1102 may be performed once a trigger 1106 is received at the CCF. The trigger 1106 may be, for example, an indication to/realization of the CCF that one or more new UEs have successfully performed a RACH procedure with at least one base station and is therefore newly attached to the network.

Once the trigger 1106 is received, the method 1102 proceeds to a measurement report request procedure 1108. The CCF sends a measurement reporting request to currently connected base station(s) and UE(s) to measure any parameters (e.g., P(s,u)) that may contribute to target functions E(u|C(u)) for the UE(s) in question. These connected base station(s) and UE(s) respond with the requested measurement reports having these parameters.

The method 1102 then proceeds to target function evaluation 1110. The CCF evaluates E(u|C(u)∪s) for each of the UE(s) in question assuming that the candidate base station s is added to the current cluster C(u) for that UE.

The method 1102 then proceeds to the cluster update procedure 1112. It is contemplated that in some embodiments of the greedy algorithm of FIG. 11, for a reduced level of complexity, the CCF determines to add the candidate base station s to the UE's cluster C(u) in the case where the function E(u|C(u)∪s) with respect to the particular UE u and base station s under consideration is improved.

Note that in alternative cases, a CCF might instead determine to add the candidate base station s to the UE's cluster C(u) in the case that an overall network-based target function (e.g., Σ_{u∈U,s∈S}E(u|C(u)∪s) or Π_{u∈U,s∈S}E(u|C(u)∪s)) improves after the addition of the base station s. These formulae may result in a more comprehensive/network-wide reflection of the effect of adding base station s to the cluster C(u) of the UE u over a more straightforward use of E(u|C(u)∪s) (at the cost of additional complexity).

In the case that multiple evaluations of the target function used (e.g., E(u|C(u)∪s), Σ_{u∈U,s∈S}E(u|C(u)∪s), or Π_{u∈U,s∈S}E(u|C(u)∪s)) with respect to the UE(s) and candidate base station(s) as described correspond to improvements in more than one applicable case, the network may proceed at this stage with the candidate base station s and UE u that give the largest/best calculated improvement.

The method 1102 then proceeds to the reconfiguration request procedure 1114. The CCF sends a reconfiguration request messaging to the UE u via its currently connected cluster C(u). This reconfiguration request messaging may include information about the base station s, non-contention RACH configuration information, and/or a pre-set timer for the UE u to respond to the reconfiguration request.

The method 1102 then proceeds to the registration handshake procedure 1116. Within the duration of the pre-set time, the UE u either accepts or rejects the reconfiguration request requesting the addition of the candidate base station s to the cluster C(u) serving the UE. If the UE accepts the reconfiguration request, it responds via its connected cluster C(u), initiates a RACH procedure with the candidate base station s, and starts the registration process (all within the timer duration). If the UE rejects the reconfiguration request, it responds via its connected cluster C(u) and the network returns to/performs another measurement report request procedure 1108.

As illustrated, the portions of the method 1102 from the measurement report request procedure 1108 to the registration handshake procedure 1116 may then repeat 1118 until either no further improvement to a target function can be achieved with respect to the UE(s) in question and/or until a maximum number of base stations in the cluster(s) at the UE(s) in question (e.g., per capability(s) of those UE(s)) is reached. Accordingly, the CCF may determine to repeat these portions of greedy algorithm upon determining that such conditions are not yet reached in any given case.

In a second method for initial clustering, a downlink (DL)-based algorithm may be implemented. The UE performs an SSB search (e.g., analogous to methods from legacy systems (e.g., some NR and/or LTE systems)) to establish a connection (e.g., when the UE powers on, exits from airplane mode, enters the geography covered by the RAN, etc.). As a result of this SSB search, the UE may obtain a list of (base station ID, received signal power) pairs. In this context, the received signal power may be the primary synchronization signal (PSS)/secondary synchronization signal (SSS) received power, a PBCH received power, an RSRP, etc.

The UE proceeds to attempt network attachment, starting with a RACH procedure with a base station selected (e.g., in response to the SSB search). As an early step during this RACH procedure, the UE provides a list (base station ID, received signal power) to the network as a measurement report attendant to the initial clustering procedure.

The network (e.g., a CCF of the network) may refer to this list to determine/develop candidate base stations for creating the initial cluster. The network will have the power to modify a cluster that is serving the UE (e.g., add/remove base stations to the cluster that is serving the UE) corresponding to this UE report. In such context, it may be assumed that it is up to the network to notify base stations of existence of the UE.

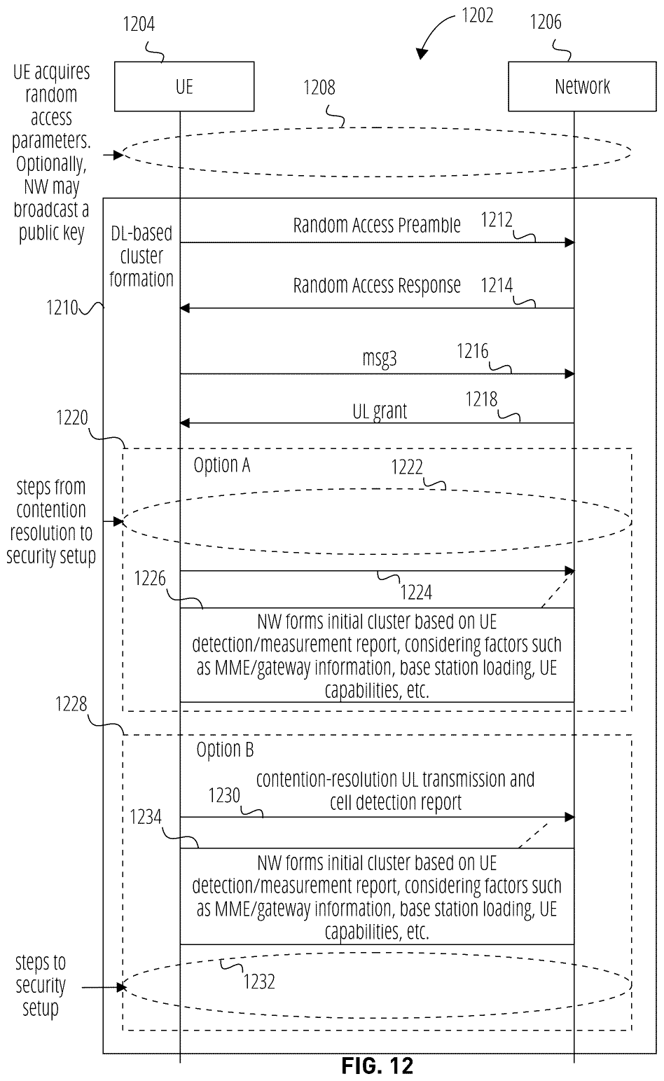

FIG. 12 illustrates a flow diagram 1202 corresponding to a RACH procedure between a UE 1204 and a network 1206, attendant to a DL-based algorithm for initial clustering, as discussed in embodiments herein. Preliminarily, as illustrated, the UE 1204 acquires 1208 random access parameters from the network 1206. Optionally, the network 1206 may broadcast a public key for the UE to use in relation to the RACH procedure.

Then, in a DL-based cluster formation phase 1210, the UE 1204 sends 1212 the network 1206 (e.g., a base station of the network) a random access (RA) preamble. In response, the network 1206 sends 1214 a random access response. Attendant to the RACH procedure, the UE follows up by sending 1216 a Message 3, to which the network 1206 replies by sending 1218 an uplink (UL) grant to the UE 1204.

At this juncture, there are two options as to when the UE may send its detection/measurement report to the network (as has been described). Under a first option 1220 (“Option A”), the UE finishes the entire random access procedure by completing the contention resolution and security setup 1222 (including key exchange) portion of the RACH procedure prior to sending 1224 the measurement report to the network. As illustrated, the network (e.g., via a CCF) may then form 1226 the initial cluster of the UE based on this detection/measurement report, considering factors such as mobility management entity and/or gateway information, base station loading, UE capabilities, etc.

Under a second option 1228, the random access procedure may be used. Because there may be no strict need to send an encrypted detection/measurement report for purposes of initial cluster formation, the UE may send 1230 the detection/measurement report to the network 1206 right after/alongside contention resolution information, prior to the performance of any procedures for security setup 1232 between the UE 1204 and the network 1206. As illustrated, this allows the network 1206 (e.g., via a CCF) to form 1234 the initial cluster for the UE based on this detection/measurement report earlier in the process as compared to the first option 1220. As before, the network 1206 may form 1234 the initial cluster for the UE based on the detection/measurement report by considering factors such as mobility management entity and/or gateway information, base station loading, UE capabilities, etc.

In a third method for initial clustering, a UL-based algorithm may be implemented. The UE attempts a RACH procedure to fulfill its intention to attach to the network. Base stations of the network may measure a received power from the UE using one or more UL messages of this RACH procedure (e.g., an RA preamble, a Message 3, a first message after conflict resolution, etc.). These base stations may report these measured values to the network (e.g., to a CCF of the network), and the network (CCF) may accordingly proceed to establish an initial cluster for the UE based on these reported measurements. Note that regardless of the values of these reported measurements, the network (CCF) remains theoretically unconstrained in making selections of base station(s) for the initial cluster.

### Clustering Update Methods

Methods for performing clustering updates (adding and/or removing base station(s) to/from an existing/established cluster that is serving a UE) are now discussed. In various cases, such methods may be actively implemented in “real time.”

In various embodiments, one or more thresholds and corresponding timer(s) for these thresholds may be used.

With respect to base station addition, it may be that a first threshold τ₁ and a corresponding timer T₁ may be used. In such cases, the UE may receive measurement reports comprising measured parameters for a uBS. These measured parameters may be, for example, RSRP values for the uBS, signal to noise ratio (SNR) values for the uBS, reference signal received quality (RSRQ) values for the uBS, etc.

The measured parameters may be treated as samples in time and then used with a filter to generate filtered measured parameters. If the value of this filtered measured parameter exceeds T₁ and the base station has been out of cluster for at least T₁ seconds, then the CCF may request that the corresponding base station joins the cluster serving the UE.

With respect to base station removal, it may be that a second threshold τ₂ and a corresponding timer T₂ may be used. In such cases, the UE may receive measurement reports comprising measured parameters for a cBS. These measured parameters may be, for example, RSRP values for the cBS, SNR values for the cBS, RSRQ values for the cBS, etc.

The measured parameters may be treated as samples in time and then used with a filter to generate filtered measured parameters. If the value of this filtered measured parameter falls below τ₂ and the base station has been in the cluster for at least T₂ seconds, then the CCF may request that the corresponding base station be removed from the cluster serving the UE.

It is contemplated that τ₁/T₁ and τ₂/T₂ may be used simultaneously. In such circumstances, it may be understood (at least implicitly) that τ₁≥τ₂. Further, note that the timers T₁ and T₂ may be independent from one another in such cases.

Note that the use of both τ₁/T₁ and τ₂/T₂ is not strictly required—in some embodiments it may be that only one of τ₁/T₁ and τ₂/T₂ as described are used.

In the above, the filtered parameter may be, for example, an IIR filter of order 1 on the measured parameters. For example, the formula

$${y}_{i} = α {x}_{i} + ( 1 - α ) {y}_{i - 1}$$

may be used, where:
xᵢ is a sample at a time i;
yᵢ₋₁ is a prior filtered measured parameter value at a time i−1;
yᵢ is a filtered measured parameter value at time i; and
α is an IIR filtering coefficient in the range [0, 1].

This real-time method may be adaptive in nature. With respect to at least some arrangements, it may be understood that transmitting control and/or shared channels from multiple base stations in a cluster may introduce opportunities for inefficiencies/conflicts that may be particularly salient in cases of otherwise favorable channel conditions for the UE. Accordingly, in some embodiments, in order to use radio resources efficiently, the thresholds τ₁ and/or τ₂ can be adaptive. When channel conditions are favorable, these thresholds may be raised higher. When channel conditions are not favorable, these thresholds may be lowered. This adaptation scheme results in smaller clusters (i.e., fewer base stations) for UEs with better channel conditions and larger clusters (i.e., more base stations) for UEs in less favorable channel conditions. Accordingly, radio resource usage/efficiency with respect to the underlying channel condition may be improved significantly, with the results that an increase in the total number of UEs that may be served is realized and/or that a user experience for UEs that do not receive a strong signal from any specific base station is enhanced.

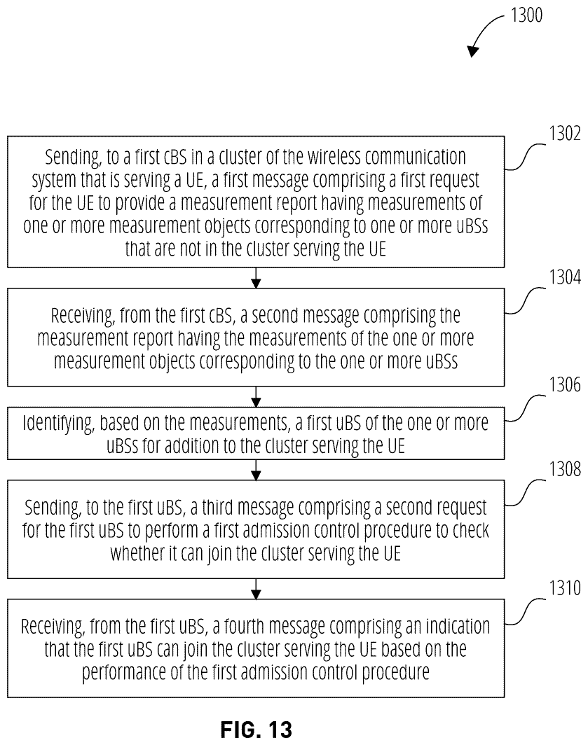

FIG. 13 illustrates a method 1300 of a CCF of a wireless communication system, according to embodiments discussed herein. The method 1300 includes sending 1302, to a first cBS in a cluster of the wireless communication system that is serving a UE, a first message comprising a first request for the UE to provide a measurement report having measurements of one or more measurement objects corresponding to one or more uBSs that are not in the cluster serving the UE. The method 1300 further includes receiving 1304, from the first cBS, a second message comprising the measurement report having the measurements of the one or more measurement objects corresponding to the one or more uBSs. The method 1300 further includes identifying 1306, based on the measurements, a first uBS of the one or more uBSs for addition to the cluster serving the UE. The method 1300 further includes sending 1308, to the first uBS, a third message comprising a second request for the first uBS to perform a first admission control procedure to check whether it can join the cluster serving the UE. The method 1300 further includes receiving 1310, from the first uBS, a fourth message comprising an indication that the first uBS can join the cluster serving the UE based on the performance of the first admission control procedure.

In some embodiments of the method 1300, the first message further indicates a timing for the measurement report.

In some embodiments of the method 1300, the first message further indicates a format of the measurement report.

In some embodiments of the method 1300, the first message further indicates that the first request corresponds to a base station addition procedure.

In some embodiments of the method 1300, the first request is further for the UE to provide UE context information for the UE; and the second message includes the UE context information for the UE. In some of these embodiments, the first message further indicates a format of the UE context information. In some of these embodiments, the first message further indicates contents of the UE context information.

In some embodiments of the method 1300, the first message further comprises a request identifier for the first request; and the second message comprises the request identifier for the first request; and the method 1300 further includes checking the second message for the measurement report based on a presence of the request identifier for the first request in the second message.

In some embodiments of the method 1300, the second message further comprises a mode indicator that identifies the second message as a pre-clustering decision response mode message.

In some embodiments of the method 1300, the second message further indicates that the first request is accepted by the UE.

In some embodiments of the method 1300, the third message further indicates an identifier for the cluster serving the UE.

In some embodiments of the method 1300, the third message further indicates UE context information for the UE.

In some embodiments of the method 1300, the third message further comprises a request identifier for the second request; and the fourth message comprises the request identifier for the second request; and the method 1300 further includes checking the fourth message for the indication that the first uBS can join the cluster serving the UE based on a presence of the request identifier for the second request in the fourth message.

In some embodiments of the method 1300, the fourth message further indicates an identifier for the cluster serving the UE.

In some embodiments of the method 1300, the fourth message further indicates that the second request is accepted by the first uBS.

In some embodiments, the method 1300 further includes receiving, from the first cBS, a fifth message comprising an indication that the UE accepts the first uBS as part of the cluster serving the UE. In some of these embodiments, the fifth message further comprises a request identifier for the second request. In some of these embodiments, the fifth message further comprises a mode indicator that identifies the fifth message as a clustering decision response mode message.

In some embodiments, the method 1300 further includes identifying, based on the measurements, a second uBS of the one or more uBSs for addition to the cluster that is serving the UE; sending, to the second uBS, a fifth message instructing the second uBS to perform a second admission control procedure to check whether it can join the cluster serving the UE; and receiving, from the second uBS, a sixth message indicating that the second uBS can join the cluster serving the UE based on the performance of the second admission control procedure.

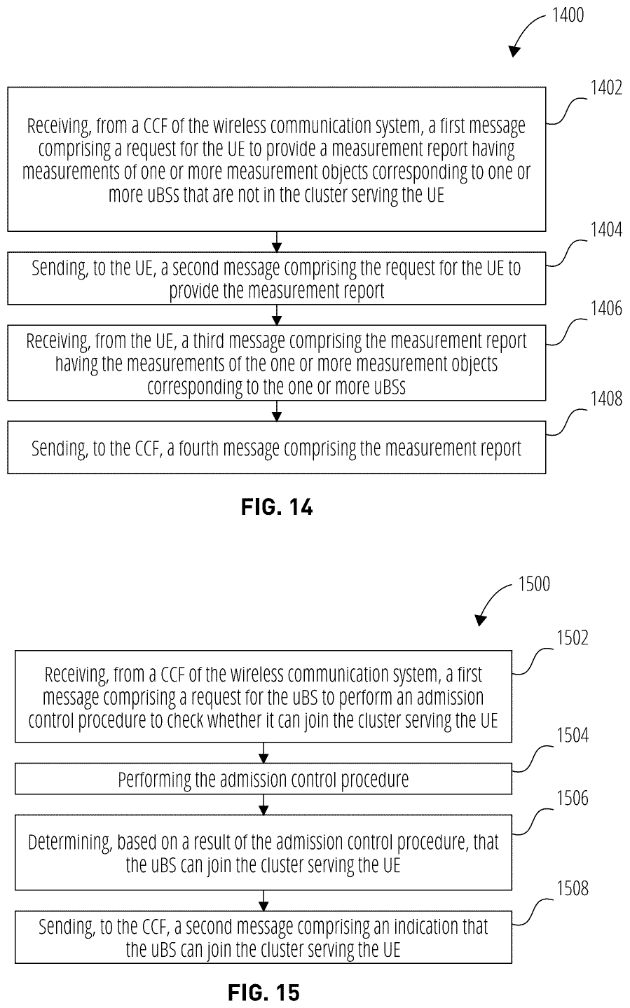

FIG. 14 illustrates a method 1400 of a cBS of a wireless communication system, according to embodiments discussed herein. The method 1400 includes receiving 1402, from a CCF of the wireless communication system, a first message comprising a request for the UE to provide a measurement report having measurements of one or more measurement objects corresponding to one or more uBSs that are not in the cluster serving the UE. The method 1400 further includes sending 1404, to the UE, a second message comprising the request for the UE to provide the measurement report. The method 1400 further includes receiving 1406, from the UE, a third message comprising the measurement report having the measurements of the one or more measurement objects corresponding to the one or more uBSs. The method 1400 further includes sending 1408, to the CCF, a fourth message comprising the measurement report.

In some embodiments of the method 1400, the first message and the second message further indicate a timing for the measurement report.

In some embodiments of the method 1400, the first message and the second message further indicate a format of the measurement report.

In some embodiments of the method 1400, the first message and the second message further indicate that the request corresponds to a base station addition procedure.

In some embodiments of the method 1400, the first message further comprises a first mode indicator that identifies the first message as a first pre-clustering decision request mode message; and the second message further comprises a second mode indicator that identifies the second message as a second pre-clustering decision request mode message.

In some embodiments of the method 1400, the request is further for the UE to provide UE context information for the UE; and the first message and the second message include the UE context information for the UE. In some of these embodiments, the first message and the second message further indicate a format of the UE context information. In some of these embodiments, the first message and the second message further indicate contents of the UE context information.

In some embodiments of the method 1400, the first message and the second message further comprise a request identifier for the request; and the third message and the fourth message comprise the request identifier for the request.

In some embodiments of the method 1400, the third message further comprises a mode indicator that identifies the second message as a first pre-clustering decision response mode message; and the fourth message further comprises a mode indicator that identifies the fourth message as a second pre-clustering decision response mode message.

In some embodiments of the method 1400, the third message and the fourth message further indicate that the request is accepted by the UE.

In some embodiments, the method 1400 further includes receiving, from a first uBS of the one or more uBSs, a fifth message comprising access configuration information for the first uBS; and sending, to the UE, a sixth message comprising the access configuration information. In some of these embodiments, the fifth message and the sixth message further comprise an identifier for the cluster serving the UE.

In some of these embodiments, the method 1400 further includes receiving, from the UE, a seventh message comprising an indication that the UE accepts the first uBS as part of the cluster that is serving the UE; and sending, to the UE, an eighth message comprising the indication that the UE accepts the first uBS as part of the cluster serving the UE. In some of these cases, the seventh message and the eighth message further comprise an identifier for the cluster serving the UE. In some of these cases, the seventh message further comprises a first mode indicator that identifies the seventh message as a first clustering decision request mode message; and the eighth message further comprises a second mode indicator that identifies the eighth message as a second clustering decision request mode message.

FIG. 15 illustrates a method 1500 of a uBS that is not in a cluster of a wireless communication that is serving a UE, according to embodiments discussed herein. The method 1500 includes receiving 1502, from a CCF of the wireless communication system, a first message comprising a request for the uBS to perform an admission control procedure to check whether it can join the cluster serving the UE. The method 1500 further includes performing 1504 the admission control procedure. The method 1500 further includes determining 1506, based on a result of the admission control procedure, that the uBS can join the cluster serving the UE. The method 1500 further includes sending 1508, to the CCF, a second message comprising an indication that the uBS can join the cluster serving the UE.

In some embodiments of the method 1500, the first message further comprises an identifier for the cluster serving the UE.

In some embodiments of the method 1500, the first message further indicates UE context information for the UE.

In some embodiments of the method 1500, the first message further comprises a request identifier for the request; and the second message comprises the request identifier for the request.

In some embodiments of the method 1500, the second message further comprises an identifier for the cluster serving the UE.

In some embodiments of the method 1500, the second message further indicates that the request is accepted by the uBS.

In some embodiments, the method 1500 further includes sending, to a connected base station (cBS) in the cluster serving the UE, a third message comprising access configuration information for the uBS. In certain such embodiments, the method 1500 further includes performing a RACH procedure with the UE to join the cluster serving the UE.

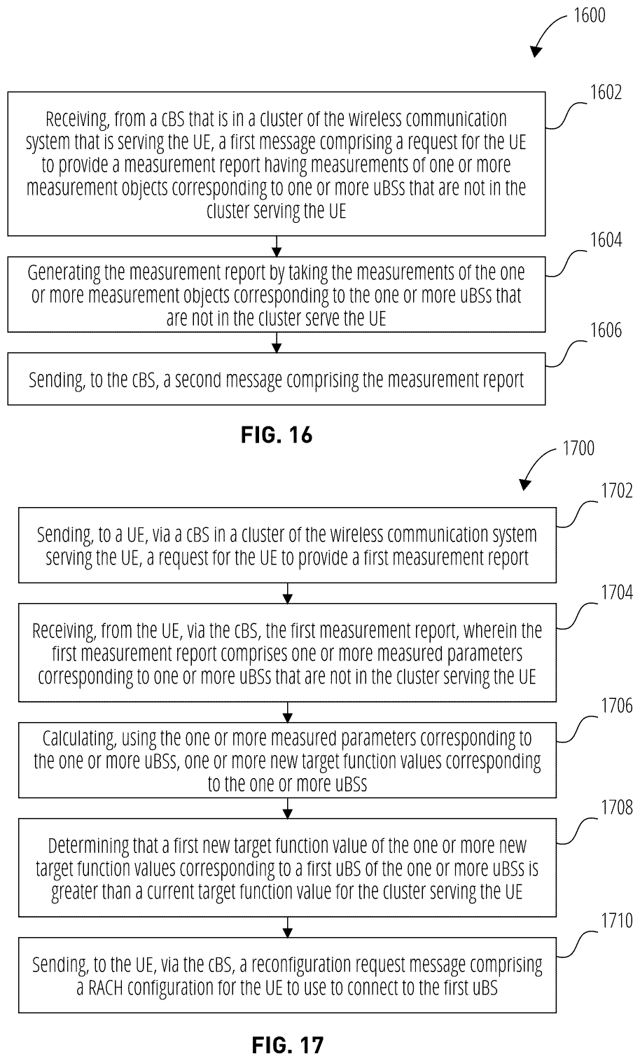

FIG. 16 illustrates a method 1600 of a UE in a wireless communication system, according to embodiments discussed herein. The method 1600 includes receiving 1602, from a cBS that is in a cluster of the wireless communication system that is serving the UE, a first message comprising a request for the UE to provide a measurement report having measurements of one or more measurement objects corresponding to one or more uBSs that are not in the cluster serving the UE. The method 1600 further includes generating 1604 the measurement report by taking the measurements of the one or more measurement objects corresponding to the one or more uBSs that are not in the cluster serves the UE. The method 1600 further includes sending 1606, to the cBS, a second message comprising the measurement report.

In some embodiments of the method 1600, the first message further indicates a timing for the measurement report.

In some embodiments of the method 1600, the first message further indicates a format of the measurement report.

In some embodiments of the method 1600, the first message further indicates that the request corresponds to a base station addition procedure.

In some embodiments of the method 1600, the first message further comprises a mode indicator that identifies the first message as a pre-clustering decision response mode message.

In some embodiments of the method 1600, the request is further for the UE to provide UE context information for the UE; and the second message includes the UE context information for the UE. In some of these embodiments, the first message further indicates a format of the UE context information. In some of these embodiments, the first message further indicates contents of the UE context information.

In some embodiments of the method 1600, the first message further comprises a request identifier for the request; and the second message comprises the request identifier for the request.

In some embodiments of the method 1600, the second message further comprises a mode indicator that identifies the second message as a pre-clustering decision response mode message.

In some embodiments of the method 1600, the second message further indicates that the request is accepted by the UE.

In some embodiments, the method 1600 further includes receiving, from the cBS, a third message comprising access configuration information for a first uBS of the one or more uBSs; sending, to the cBS, a fourth message comprising an indication that the UE accepts the first uBS as part of the cluster that is serving the UE; and performing a RACH procedure with the first uBS using the access configuration information. In some of these embodiments, the third message further comprises an identifier for the cluster serving the UE. In some of these embodiments, the third message further comprises a mode indicator that identifies the fourth message as a clustering decision response mode message. In some of these embodiments, the fourth message further comprises an identifier for the cluster serving the UE. In some of these embodiments, the fourth message further comprises a mode indicator that identifies the fourth message as a clustering decision response mode message.

FIG. 17 illustrates a method 1700 of a CCF of a wireless communication system, according to embodiments discussed herein. The method 1700 includes sending 1702, to a UE, via a cBS in a cluster of the wireless communication system serving the UE, a request for the UE to provide a first measurement report. The method 1700 further includes receiving 1704, from the UE, via the cBS, the first measurement report, wherein the first measurement report comprises one or more measured parameters corresponding to one or more uBSs that are not in the cluster serving the UE. The method 1700 further includes calculating 1706, using the one or more measured parameters corresponding to the one or more uBSs, one or more new target function values corresponding to the one or more uBSs. The method 1700 further includes determining 1708 that a first new target function value of the one or more new target function values corresponding to a first uBS of the one or more uBSs is greater than a current target function value for the cluster serving the UE. The method 1700 further includes sending 1710, to the UE, via the cBS, a reconfiguration request message comprising a RACH configuration for the UE to use to connect to the first uBS.

In some embodiments, the method 1700 further includes determining that the UE is connected to fewer than a maximum number of cBSs for the UE, and wherein the request for the UE to provide the first measurement report is sent in response to the determining that the UE is connected to fewer than the maximum number of cBSs for the UE.

In some embodiments, the method 1700 further includes determining that the UE is connected to fewer than a maximum number of cBSs for the UE; and sending, to the UE, a request for the UE to provide a second measurement report in response to the determining that the UE is connected to fewer than the maximum number of cBSs for the UE.

In some embodiments of the method 1700, each of the one or more new target function values corresponding to the one or more uBSs is generated by modifying the current target function value for the cluster serving the UE by a target function gain for adding the uBS corresponding to one of the one or more new target function values to the cluster serving the UE and by a network penalty for adding the uBS corresponding to the one of the one or more new target function values to the cluster serving the UE.

In some embodiments of the method 1700, the request for the UE to provide the first measurement report is sent in response to receiving, from the UE, an indication that the UE is capable of communicating with multiple cBSs in the cluster serving the UE.

In some embodiments of the method 1700, the reconfiguration request message further includes a timer indicating a duration within which the UE is allowed to respond to the reconfiguration request message.

In some embodiments of the method 1700, the one or more measured parameters are one or more RSRP values.

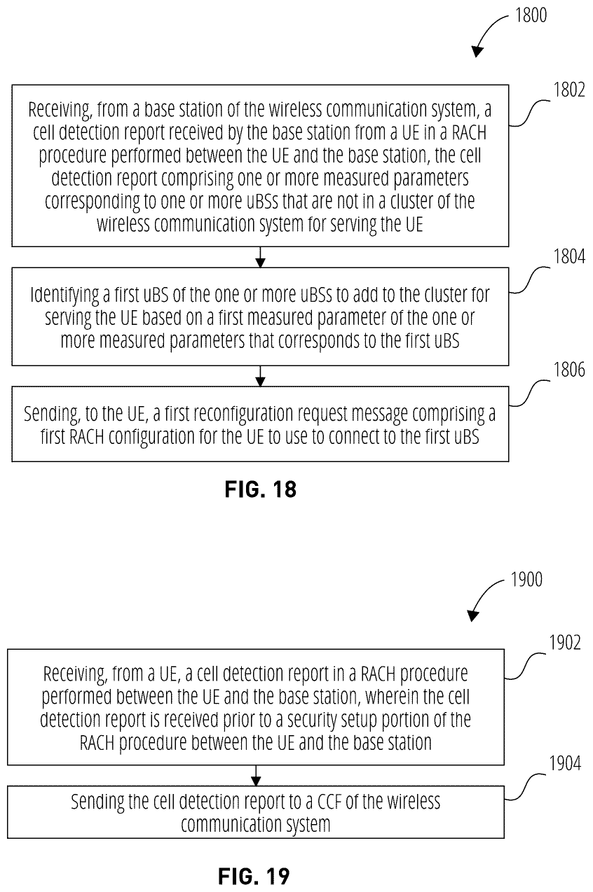

FIG. 18 illustrates a method 1800 of a CCF of a wireless communication system, according to embodiments discussed herein. The method 1800 includes receiving 1802, from a base station of the wireless communication system, a cell detection report received by the base station from a UE in a RACH procedure performed between the UE and the base station, the cell detection report comprising one or more measured parameters corresponding to one or more uBSs that are not in a cluster of the wireless communication system for serving the UE. The method 1800 further includes identifying 1804 a first uBS of the one or more uBSs to add to the cluster for serving the UE based on a first measured parameter of the one or more measured parameters that corresponds to the first uBS. The method 1800 further includes sending 1806, to the UE, a first reconfiguration request message comprising a first RACH configuration for the UE to use to connect to the first uBS.

In some embodiments, the method 1800 further includes identifying a second uBS of the one or more uBSs to add to the cluster for serving the UE based on a second measured parameter of the one or more measured parameters that corresponds to the second uBS; and sending, to the UE, a second reconfiguration request message comprising a second RACH configuration for the UE to use to connect to the second uBS.

In some embodiments of the method 1800, the cell detection report is unencrypted.

In some embodiments of the method 1800, the first measured parameter is an RSRP value.

FIG. 19 illustrates a method 1900 of a base station of a wireless communication system, according to embodiments discussed herein. The method 1900 includes receiving 1902, from a UE, a cell detection report in a RACH procedure performed between the UE and the base station, wherein the cell detection report is received prior to a security setup portion of the RACH procedure between the UE and the base station. The method 1900 further includes sending 1904 the cell detection report to a CCF of the wireless communication system.

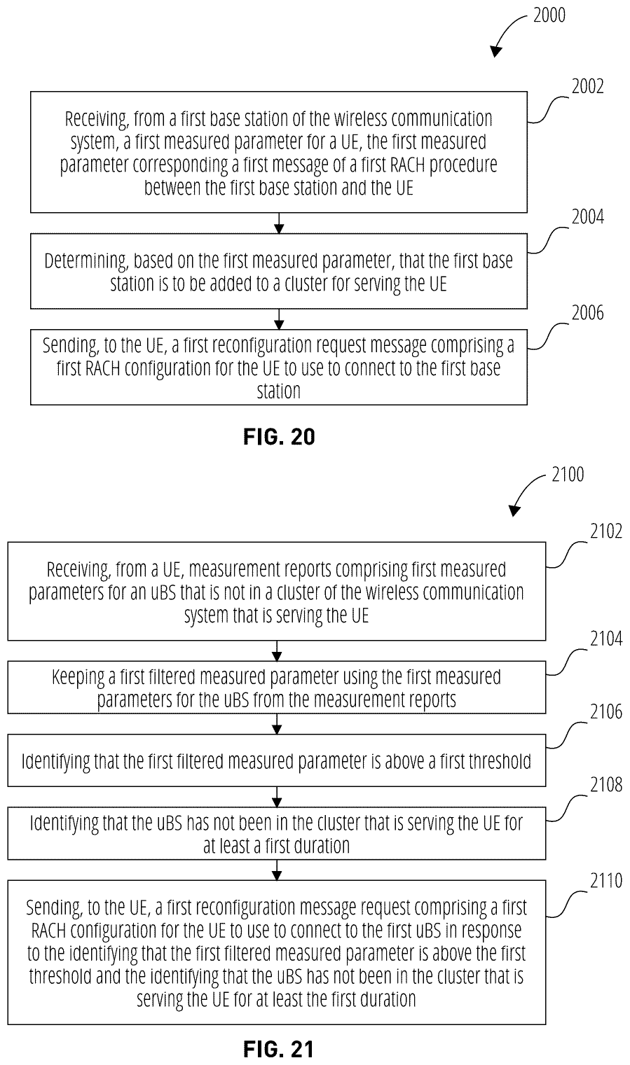

FIG. 20 illustrates a method 2000 of a CCF of a wireless communication system, according to embodiments discussed herein. The method 2000 includes receiving 2002, from a first base station of the wireless communication system, a first measured parameter for a UE, the first measured parameter corresponding a first message of a first RACH procedure between the first base station and the UE. The method 2000 further includes determining 2004, based on the first measured parameter, that the first base station is to be added to a cluster for serving the UE. The method 2000 further includes sending 2006, to the UE, a first reconfiguration request message comprising a first RACH configuration for the UE to use to connect to the first base station.

In some embodiments, the method 2000 further includes receiving, from a second base station of the wireless communication system, a second measured parameter for the UE, the second measured parameter corresponding a second message of a second RACH procedure between the second base station and the UE; determining, based on the second measured parameter, that the second base station is to be added to the cluster for serving the UE; and sending, to the UE, a second reconfiguration request message comprising a second RACH configuration for the UE to use to connect to the second base station.

In some embodiments of the method 2000, the first message of the first RACH procedure is one of an RA preamble, a message 3, or a first message after conflict resolution.

In some embodiments of the method 2000, the first measured parameter is an RSRP value.

FIG. 21 illustrates a method 2100 of a CCF of a wireless communication system, according to embodiments discussed herein. The method 2100 includes receiving 2102, from a UE, measurement reports comprising first measured parameters for a uBS that is not in a cluster of the wireless communication system that is serving the UE. The method 2100 further includes keeping 2104 a first filtered measured parameter using the first measured parameters for the uBS from the measurement reports. The method 2100 further includes identifying 2106 that the first filtered measured parameter is above a first threshold. The method 2100 further includes identifying 2108 that the uBS has not been in the cluster that is serving the UE for at least a first duration. The method 2100 further includes sending 2110, to the UE, a first reconfiguration message request comprising a first RACH configuration for the UE to use to connect to the first uBS in response to the identifying that the first filtered measured parameter is above the first threshold and the identifying that the uBS has not been in the cluster that is serving the UE for at least the first duration.

In some embodiments of the method 2100, the first measured parameters are RSRP values for the uBS.

In some embodiments of the method 2100, the first measured parameters are SNR values for the uBS.

In some embodiments of the method 2100, the first measured parameters are RSRQ values for the uBS.

In some embodiments of the method 2100, the measurement reports further comprise second measured parameters for the uBS; and the method 2100 further includes: keeping a second filtered measured parameter using the second measured parameters for the uBS from the measurement reports; identifying that the second measured parameter is above a second threshold; and wherein the sending, to the UE, the first reconfiguration message request is further in response to the identifying that the second filtered measured parameter is above the second threshold. In some of these embodiments, the first measured parameters are RSRP values for the uBS, and wherein the second measured parameters are RSRQ values for the uBS.

In some embodiments of the method 2100, the first filtered measured parameter is kept by using the first measured parameters as samples x over time according to a formula

$${y}_{i} = α {x}_{i} + ( 1 - α ) {y}_{i - 1}$$

where:
xᵢ is a sample at a time i;
yᵢ₋₁ is a prior filtered measured parameter value at a time i−1;
yᵢ is a filtered measured parameter value at time i; and
α is an IIR filtering coefficient in the range [0, 1].

In some embodiments, the method 2100 further includes raising the first threshold in response to determining that channel conditions for the UE are improving.

In some embodiments, the method 2100 further includes lowering the first threshold in response to determining that channel conditions for the UE are declining.

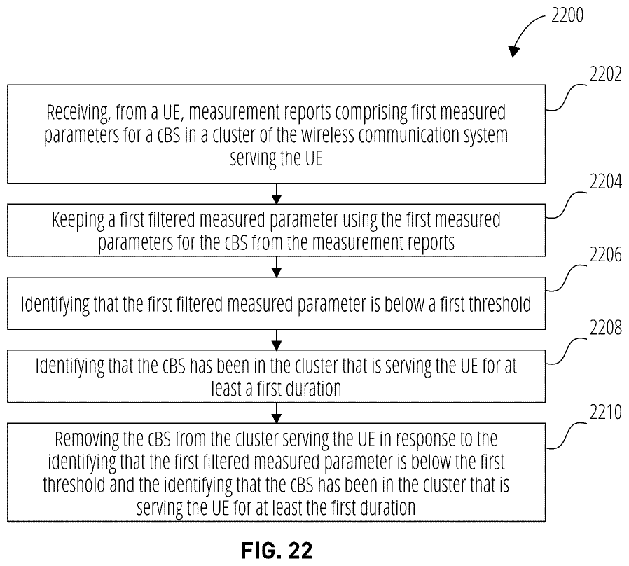

FIG. 22 illustrates a method 2200 of a CCF of a wireless communication system, according to embodiments discussed herein. The method 2200 includes receiving 2202, from a UE, measurement reports comprising first measured parameters for a cBS in a cluster of the wireless communication system serving the UE. The method 2200 further includes keeping 2204 a first filtered measured parameter using the first measured parameters for the cBS from the measurement reports. The method 2200 further includes identifying 2206 that the first filtered measured parameter is below a first threshold. The method 2200 further includes identifying 2208 that the cBS has been in the cluster that is serving the UE for at least a first duration. The method 2200 further includes removing 2210 the cBS from the cluster serving the UE in response to the identifying that the first filtered measured parameter is below the first threshold and the identifying that the cBS has been in the cluster that is serving the UE for at least the first duration.

In some embodiments of the method 2200, the first measured parameters are RSRP values for the cBS.

In some embodiments of the method 2200, the first measured parameters are SNR values for the cBS.

In some embodiments of the method 2200, the first measured parameters are RSRQ values for the cBS.

In some embodiments of the method 2200, the measurement reports further comprise second measured parameters for the cBS; and the method 2200 further includes: keeping a second filtered measured parameter using the second measured parameters for the cBS from the measurement reports; identifying that the second measured parameter is below a second threshold; and wherein the removing the cBS from the cluster serving the UE is further in response to the identifying that the second filtered measured parameter is below the second threshold. In some of these embodiments, the first measured parameters are RSRP values for the cBS, and wherein the second measured parameters are RSRQ values for the cBS.

In some embodiments of the method 2200, the first filtered measured parameter is kept by using the first measured parameters as samples x over time according to a formula

$${y}_{i} = α {x}_{i} + ( 1 - α ) {y}_{i - 1}$$

where:
xᵢ is a sample at a time i;
yᵢ₋₁ is a prior filtered measured parameter value at a time i−1;
yᵢ is a filtered measured parameter value at time i; and
α is an IIR filtering coefficient in the range [0, 1].

In some embodiments, the method 2200 further includes raising the first threshold in response to determining that channel conditions for the UE are improving.

In some embodiments, the method 2200 further includes lowering the first threshold in response to determining that channel conditions for the UE are declining.

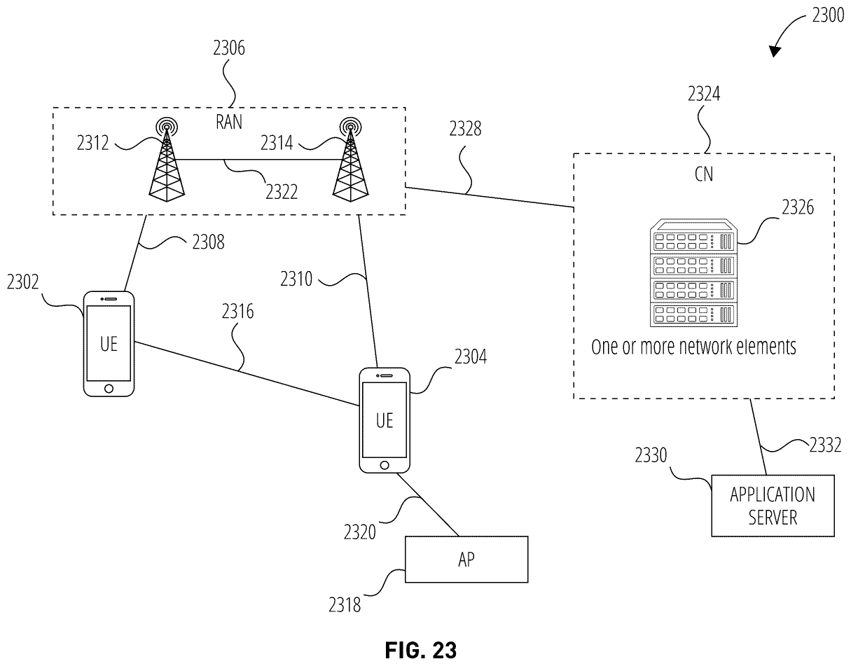

FIG. 23 illustrates an example architecture of a wireless communication system 2300, according to embodiments disclosed herein.

As shown by FIG. 23, the wireless communication system 2300 includes UE 2302 and UE 2304 (although any number of UEs may be used). In this example, the UE 2302 and the UE 2304 are illustrated as smartphones (e.g., handheld touchscreen mobile computing devices connectable to one or more cellular networks), but may also comprise any mobile or non-mobile computing device configured for wireless communication.

The UE 2302 and UE 2304 may be configured to communicatively couple with a RAN 2306. In embodiments, the RAN 2306 may be NG-RAN, E-UTRAN, etc. The UE 2302 and UE 2304 utilize connections (or channels) (shown as connection 2308 and connection 2310, respectively) with the RAN 2306, each of which comprises a physical communications interface. The RAN 2306 can include one or more base stations (such as base station 2312 and base station 2314) that enable the connection 2308 and connection 2310.

In this example, the connection 2308 and connection 2310 are air interfaces to enable such communicative coupling, and may be consistent with RAT(s) used by the RAN 2306, such as, for example, an LTE and/or NR.

In some embodiments, the UE 2302 and UE 2304 may also directly exchange communication data via a sidelink interface 2316. The UE 2304 is shown to be configured to access an access point (shown as AP 2318) via connection 2320. By way of example, the connection 2320 can comprise a local wireless connection, such as a connection consistent with any IEEE 802.11 protocol, wherein the AP 2318 may comprise a Wi-Fi® router. In this example, the AP 2318 may be connected to another network (for example, the Internet) without going through a CN 2324.

In embodiments, the UE 2302 and UE 2304 can be configured to communicate using orthogonal frequency division multiplexing (OFDM) communication signals with each other or with the base station 2312 and/or the base station 2314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2312 or base station 2314 may be implemented as one or more software entities running on server computers as part of a virtual network. In addition, or in other embodiments, the base station 2312 or base station 2314 may be configured to communicate with one another via interface 2322. In embodiments where the wireless communication system 2300 is an LTE system (e.g., when the CN 2324 is an EPC), the interface 2322 may be an X2 interface. The X2 interface may be defined between two or more base stations (e.g., two or more eNBs and the like) that connect to an EPC, and/or between two eNBs connecting to the EPC. In embodiments where the wireless communication system 2300 is an NR system (e.g., when CN 2324 is a 5GC), the interface 2322 may be an Xn interface. The Xn interface is defined between two or more base stations (e.g., two or more gNBs and the like) that connect to 5GC, between a base station 2312 (e.g., a gNB) connecting to 5GC and an eNB, and/or between two eNBs connecting to 5GC (e.g., CN 2324).

The RAN 2306 is shown to be communicatively coupled to the CN 2324. The CN 2324 may comprise one or more network elements 2326, which are configured to offer various data and telecommunications services to customers/subscribers (e.g., users of UE 2302 and UE 2304) who are connected to the CN 2324 via the RAN 2306. The components of the CN 2324 may be implemented in one physical device or separate physical devices including components to read and execute instructions from a machine-readable or computer-readable medium (e.g., a non-transitory machine-readable storage medium).

In embodiments, the CN 2324 may be an EPC, and the RAN 2306 may be connected with the CN 2324 via an S1 interface 2328. In embodiments, the S1 interface 2328 may be split into two parts, an S1 user plane (S1-U) interface, which carries traffic data between the base station 2312 or base station 2314 and a serving gateway (S-GW), and the S1-MME interface, which is a signaling interface between the base station 2312 or base station 2314 and mobility management entities (MMEs).

In embodiments, the CN 2324 may be a 5GC, and the RAN 2306 may be connected with the CN 2324 via an NG interface 2328. In embodiments, the NG interface 2328 may be split into two parts, an NG user plane (NG-U) interface, which carries traffic data between the base station 2312 or base station 2314 and a user plane function (UPF), and the S1 control plane (NG-C) interface, which is a signaling interface between the base station 2312 or base station 2314 and access and mobility management functions (AMFs).

Generally, an application server 2330 may be an element offering applications that use internet protocol (IP) bearer resources with the CN 2324 (e.g., packet switched data services). The application server 2330 can also be configured to support one or more communication services (e.g., VoIP sessions, group communication sessions, etc.) for the UE 2302 and UE 2304 via the CN 2324. The application server 2330 may communicate with the CN 2324 through an IP communications interface 2332.

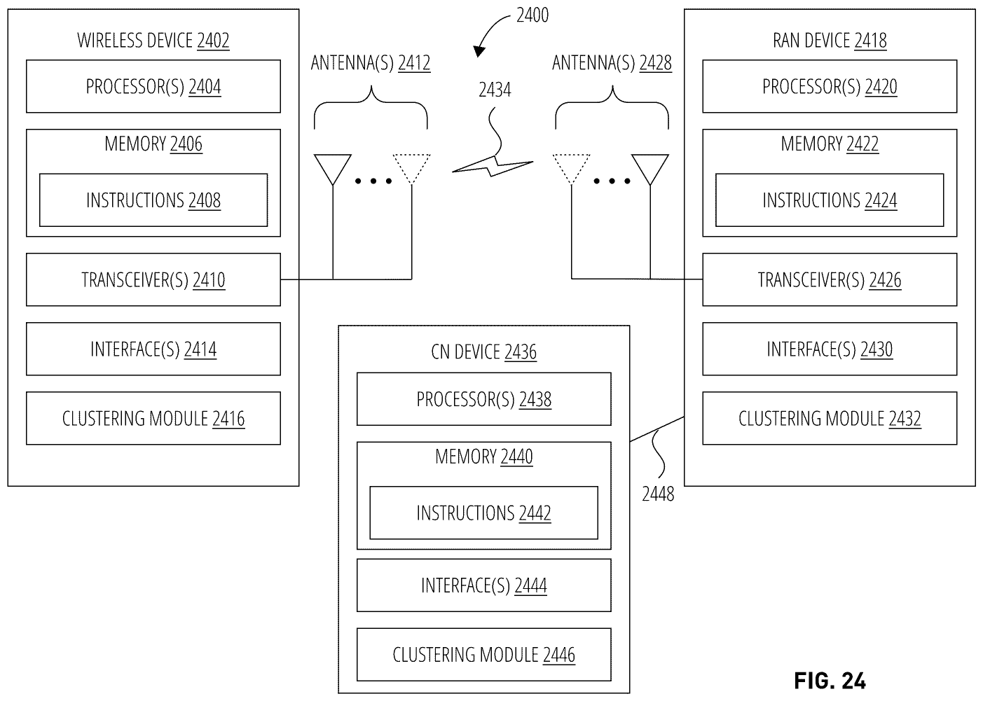

FIG. 24 illustrates a system 2400 for performing signaling 2434 between a wireless device 2402 and a RAN device 2418, according to embodiments disclosed herein. The system 2400 may be a portion of a wireless communications system as herein described. The wireless device 2402 may be, for example, a UE of a wireless communication system. The RAN device 2418 may be, for example, a base station (e.g., an eNB, a gNB, or a sixth generation base station) of a wireless communication system.

The wireless device 2402 may include one or more processor(s) 2404. The processor(s) 2404 may execute instructions such that various operations of the wireless device 2402 are performed, as described herein. The processor(s) 2404 may include one or more baseband processors implemented using, for example, a CPU, a digital signal processor (DSP), an application specific integrated circuit (ASIC), a controller, a field programmable gate array (FPGA) device, another hardware device, a firmware device, or any combination thereof configured to perform the operations described herein.

The wireless device 2402 may include a memory 2406. The memory 2406 may be a non-transitory computer-readable storage medium that stores instructions 2408 (which may include, for example, the instructions being executed by the processor(s) 2404). The instructions 2408 may also be referred to as program code or a computer program. The memory 2406 may also store data used by, and results computed by, the processor(s) 2404.

The wireless device 2402 may include one or more transceiver(s) 2410 that may include radio frequency (RF) transmitter circuitry and/or receiver circuitry that use the antenna(s) 2412 of the wireless device 2402 to facilitate signaling (e.g., the signaling 2434) to and/or from the wireless device 2402 with other devices (e.g., the RAN device 2418) according to corresponding RATs.

The wireless device 2402 may include one or more antenna(s) 2412 (e.g., one, two, four, or more). For embodiments with multiple antenna(s) 2412, the wireless device 2402 may leverage the spatial diversity of such multiple antenna(s) 2412 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 2402 may be accomplished according to precoding (or digital beamforming) that is applied at the wireless device 2402 that multiplexes the data streams across the antenna(s) 2412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2402 may implement analog beamforming techniques, whereby phases of the signals sent by the antenna(s) 2412 are relatively adjusted such that the (joint) transmission of the antenna(s) 2412 can be directed (this is sometimes referred to as beam steering).

The wireless device 2402 may include one or more interface(s) 2414. The interface(s) 2414 may be used to provide input to or output from the wireless device 2402. For example, a wireless device 2402 that is a UE may include interface(s) 2414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2410/antenna(s) 2412 already described) that allow for communication between the UE and other devices and may operate according to known protocols (e.g., Wi-Fi®, Bluetooth®, and the like).

The wireless device 2402 may include a clustering module 2416. The clustering module 2416 may be implemented via hardware, software, or combinations thereof. For example, the clustering module 2416 may be implemented as a processor, circuit, and/or instructions 2408 stored in the memory 2406 and executed by the processor(s) 2404. In some examples, the clustering module 2416 may be integrated within the processor(s) 2404 and/or the transceiver(s) 2410. For example, the clustering module 2416 may be implemented by a combination of software components (e.g., executed by a DSP or a general processor) and hardware components (e.g., logic gates and circuitry) within the processor(s) 2404 or the transceiver(s) 2410.

The clustering module 2416 may be used for various aspects of the present disclosure, for example, aspects of FIG. 1 to FIG. 22. The clustering module 2416 may be configured to transmit, receive, and/or use UE message types for cell-free clustering, as are discussed herein. Such messages may operate/be used to enable initial clustering methods and/or clustering update methods used by a CCF to maintain/modify a cluster, as are discussed herein.

The RAN device 2418 may include one or more processor(s) 2420. The processor(s) 2420 may execute instructions such that various operations of the RAN device 2418 are performed, as described herein. The processor(s) 2420 may include one or more baseband processors implemented using, for example, a CPU, a DSP, an ASIC, a controller, an FPGA device, another hardware device, a firmware device, or any combination thereof configured to perform the operations described herein.

The RAN device 2418 may include a memory 2422. The memory 2422 may be a non-transitory computer-readable storage medium that stores instructions 2424 (which may include, for example, the instructions being executed by the processor(s) 2420). The instructions 2424 may also be referred to as program code or a computer program. The memory 2422 may also store data used by, and results computed by, the processor(s) 2420.

The RAN device 2418 may include one or more transceiver(s) 2426 that may include RF transmitter circuitry and/or receiver circuitry that use the antenna(s) 2428 of the RAN device 2418 to facilitate signaling (e.g., the signaling 2434) to and/or from the RAN device 2418 with other devices (e.g., the wireless device 2402) according to corresponding RATs.

The RAN device 2418 may include one or more antenna(s) 2428 (e.g., one, two, four, or more). In embodiments having multiple antenna(s) 2428, the RAN device 2418 may perform MIMO, digital beamforming, analog beamforming, beam steering, etc., as has been described.

The RAN device 2418 may include one or more interface(s) 2430. The interface(s) 2430 may be used to provide input to or output from the RAN device 2418. For example, a RAN device 2418 that is a base station may include interface(s) 2430 made up of transmitters, receivers, and other circuitry (e.g., other than the transceiver(s) 2426/antenna(s) 2428 already described) that enables the base station to communicate with other equipment in a core network, and/or that enables the base station to communicate with external networks, computers, databases, and the like for purposes of operations, administration, and maintenance of the base station or other equipment operably connected thereto. As another example, the RAN device 2418 may communicate with the CN device 2436 on an interface 2448 of the interface(s) 2430 (which, in, for example, NR cases, may be an NG interface or in LTE cases may be an S1 interface).

The RAN device 2418 may include a clustering module 2432. The clustering module 2432 may be implemented via hardware, software, or combinations thereof. For example, the clustering module 2432 may be implemented as a processor, circuit, and/or instructions 2424 stored in the memory 2422 and executed by the processor(s) 2420. In some examples, the clustering module 2432 may be integrated within the processor(s) 2420 and/or the transceiver(s) 2426. For example, the clustering module 2432 may be implemented by a combination of software components (e.g., executed by a DSP or a general processor) and hardware components (e.g., logic gates and circuitry) within the processor(s) 2420 or the transceiver(s) 2426.

The clustering module 2432 may be used for various aspects of the present disclosure, for example, aspects of FIG. 1 through FIG. 22. The clustering module 2432 may be configured to transmit, receive, and/or use base station message types used for cell-free clustering, as are discussed herein. Such messages may operate/be used to enable initial clustering methods and/or clustering update methods used by a CCF to maintain/modify a cluster, as are discussed herein. In some embodiments, the clustering module 2432 may also configure the RAN device 2418 to operate (either in whole or in part) the CCF.

The CN device 2436 may include one or more processor(s) 2438. The processor(s) 2438 may execute instructions such that various operations of the CN device 2436 are performed, as described herein. The processor(s) 2438 may include one or more baseband processors implemented using, for example, a CPU, a DSP, an ASIC, a controller, an FPGA device, another hardware device, a firmware device, or any combination thereof configured to perform the operations described herein.

The CN device 2436 may include a memory 2440. The memory 2440 may be a non-transitory computer-readable storage medium that stores instructions 2442 (which may include, for example, the instructions being executed by the processor(s) 2438). The instructions 2442 may also be referred to as program code or a computer program. The memory 2440 may also store data used by, and results computed by, the processor(s) 2438.

The CN device 2436 may include one or more interface(s) 2444. The interface(s) 2444 may be used to provide input to or output from the CN device 2436. For example, a CN device 2436 may communicate with the RAN device 2418 on an interface 2448 of the interface(s) 2444 (which, in, for example, NR cases, may be an NG interface or in LTE cases may be an S1 interface).

The CN device 2436 may include a clustering module 2446. The clustering module 2446 may be implemented via hardware, software, or combinations thereof. For example, the clustering module 2446 may be implemented as a processor, circuit, and/or instructions 2442 stored in the memory 2440 and executed by the processor(s) 2438. In some examples, the clustering module 2446 may be integrated within the processor(s) 2438. For example, the clustering module 2446 may be implemented by a combination of software components (e.g., executed by a DSP or a general processor) and hardware components (e.g., logic gates and circuitry) within the processor(s) 2438.

The clustering module 2446 may be used for various aspects of the present disclosure, for example, aspects of FIG. 1 through FIG. 22. The clustering module 2446 may be configured to use/cause to be transmitted CCF message types used for cell-free clustering, as are discussed herein. Such messages may operate/be used to enable initial clustering methods and/or clustering update methods used by the CCF to maintain/modify a cluster, as are discussed herein.

Embodiments contemplated herein include an apparatus comprising means to perform one or more elements of the method 1600. This apparatus may be, for example, an apparatus of a UE (such as a wireless device 2402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of a UE (such as a memory 2406 of a wireless device 2402 that is a UE, as described herein).

Embodiments contemplated herein include an apparatus comprising logic, modules, or circuitry to perform one or more elements of the method 1600. This apparatus may be, for example, an apparatus of a UE (such as a wireless device 2402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of a UE (such as a wireless device 2402 that is a UE, as described herein).

Embodiments contemplated herein include a signal as described in or related to one or more elements of the method 1600.

Embodiments contemplated herein include a computer program or computer program product comprising instructions, wherein execution of the program by a processor is to cause the processor to carry out one or more elements of the method 1600. The processor may be a processor of a UE (such as a processor(s) 2404 of a wireless device 2402 that is a UE, as described herein). These instructions may be, for example, located in the processor and/or on a memory of the UE (such as a memory 2406 of a wireless device 2402 that is a UE, as described herein).

Embodiments contemplated herein include an apparatus comprising means to perform one or more elements of any of the method 1400, the method 1500 and/or the method 1900. This apparatus may be, for example, an apparatus of a base station (such as a RAN device 2418 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1400, the method 1500 and/or the method 1900. This non-transitory computer-readable media may be, for example, a memory of a base station (such as a memory 2422 of a RAN device 2418 that is a base station, as described herein).

Embodiments contemplated herein include an apparatus comprising logic, modules, or circuitry to perform one or more elements of any of the method 1400, the method 1500 and/or the method 1900. This apparatus may be, for example, an apparatus of a base station (such as a RAN device 2418 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1400, the method 1500 and/or the method 1900. This apparatus may be, for example, an apparatus of a base station (such as a RAN device 2418 that is a base station, as described herein).

Embodiments contemplated herein include a signal as described in or related to one or more elements of any of the method 1400, the method 1500 and/or the method 1900.

Embodiments contemplated herein include a computer program or computer program product comprising instructions, wherein execution of the program by a processing element is to cause the processing element to carry out one or more elements of any of the method 1400, the method 1500 and/or the method 1900. The processor may be a processor of a base station (such as a processor(s) 2420 of a RAN device 2418 that is a base station, as described herein). These instructions may be, for example, located in the processor and/or on a memory of the base station (such as a memory 2422 of a RAN device 2418 that is a base station, as described herein).

Embodiments contemplated herein include an apparatus comprising means to perform one or more elements of any of the method 1300, the method 1700, the method 1800, the method 2000, the method 2100, and/or the method 2200. This apparatus may be, for example, an apparatus of a base station (such as a RAN device 2418 that is a base station, as described herein) and/or of a CN. It is further contemplated that this apparatus may be one of many such apparatuses working together in a distributed fashion to perform the one or more elements of any of the method 1300, the method 1700, the method 1800, the method 2000, the method 2100, and/or the method 2200.

Embodiments contemplated herein include one or more non-transitory computer-readable media comprising instructions to cause an electronic device, upon execution of the instructions by one or more processors of the electronic device, to perform one or more elements of any of the method 1300, the method 1700, the method 1800, the method 2000, the method 2100, and/or the method 2200. This non-transitory computer-readable media may be, for example, a memory of a base station (such as a memory 2422 of a RAN device 2418 that is a base station, as described herein) and/or of a CN. It is further contemplated that the electronic device may be one of many such electronic devices working together in a distributed fashion to perform the one or more elements of any of the method 1300, the method 1700, the method 1800, the method 2000, the method 2100, and/or the method 2200.

Embodiments contemplated herein include an apparatus comprising logic, modules, or circuitry to perform one or more elements of any of the method 1300, the method 1700, the method 1800, the method 2000, the method 2100, and/or the method 2200. This apparatus may be, for example, an apparatus of a base station (such as a RAN device 2418 that is a base station, as described herein) and/or of a CN. It is further contemplated that this apparatus may be one of many such apparatuses working together in a distributed fashion to perform the one or more elements of any of the method 1300, the method 1700, the method 1800, the method 2000, the method 2100, and/or the method 2200.

Embodiments contemplated herein include an apparatus comprising: one or more processors and one or more computer-readable media comprising instructions that, when executed by the one or more processors, cause the one or more processors to perform one or more elements of any of the method 1300, the method 1700, the method 1800, the method 2000, the method 2100, and/or the method 2200. This apparatus may be, for example, an apparatus of a base station (such as a RAN device 2418 that is a base station, as described herein) and/or of a CN. It is further contemplated that this apparatus may be one of many such apparatuses working together in a distributed fashion to perform the one or more elements of any of the method 1300, the method 1700, the method 1800, the method 2000, the method 2100, and/or the method 2200.

Embodiments contemplated herein include a signal as described in or related to one or more elements of any of the method 1300, the method 1700, the method 1800, the method 2000, the method 2100, and/or the method 2200.

Embodiments contemplated herein include a computer program or computer program product comprising instructions, wherein execution of the program by a processing element is to cause the processing element to carry out one or more elements of any of the method 1300, the method 1700, the method 1800, the method 2000, the method 2100, and/or the method 2200. The processor may be a processor of a base station (such as a processor(s) 2420 of a RAN device 2418 that is a base station, as described herein) and/or a CN. These instructions may be, for example, located in the processor and/or on a memory of the base station (such as a memory 2422 of a RAN device 2418 that is a base station, as described herein) and/or the CN. It is further contemplated that the processing element may be one of many such processing elements working together in a distributed fashion to perform the one or more elements of any of the method 1300, the method 1700, the method 1800, the method 2000, the method 2100, and/or the method 2200.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a clustering control function (CCF) of a wireless communication system, comprising:
sending, to a user equipment (UE), via a connected base station (cBS) in a cluster of the wireless communication system serving the UE, a request for the UE to provide a first measurement report;
receiving, from the UE, via the cBS, the first measurement report, wherein the first measurement report comprises one or more measured parameters corresponding to one or more unconnected base stations (uBSs) that are not in the cluster serving the UE;
calculating, using the one or more measured parameters corresponding to the one or more uBSs, one or more new target function values corresponding to the one or more uBSs;
determining that a first new target function value of the one or more new target function values corresponding to a first uBS of the one or more uBSs is greater than a current target function value for the cluster serving the UE; and
sending, to the UE, via the cBS, a reconfiguration request message comprising a random access channel (RACH) configuration for the UE to use to connect to the first uBS.

2. The method of claim 1, further comprising determining that the UE is connected to fewer than a maximum number of cBSs for the UE, and wherein the request for the UE to provide the first measurement report is sent in response to the determining that the UE is connected to fewer than the maximum number of cBSs for the UE.

3. The method of claim 1, further comprising:
determining that the UE is connected to fewer than a maximum number of cBSs for the UE; and
sending, to the UE, a request for the UE to provide a second measurement report in response to the determining that the UE is connected to fewer than the maximum number of cBSs for the UE.

4. The method of claim 1, wherein each of the one or more new target function values corresponding to the one or more uBSs is generated by modifying the current target function value for the cluster serving the UE by a target function gain for adding the uBS corresponding to one of the one or more new target function values to the cluster serving the UE and by a network penalty for adding the uBS corresponding to the one of the one or more new target function values to the cluster serving the UE.

5. The method of claim 1, wherein the request for the UE to provide the first measurement report is sent in response to receiving, from the UE, an indication that the UE is capable of communicating with multiple cBSs in the cluster serving the UE.

6. The method of claim 1, wherein the reconfiguration request message further includes a timer indicating a duration within which the UE is allowed to respond to the reconfiguration request message.

7. The method of claim 1, wherein the one or more measured parameters are one or more reference signal received power (RSRP) values.

8. A method of a clustering control function (CCF) of a wireless communication system, comprising:
receiving, from a base station of the wireless communication system, a cell detection report received by the base station from a user equipment (UE) in a random access channel (RACH) procedure performed between the UE and the base station, the cell detection report comprising one or more measured parameters corresponding to one or more unconnected base stations (uBSs) that are not in a cluster of the wireless communication system for serving the UE; and
identifying a first uBS of the one or more uBSs to add to the cluster for serving the UE based on a first measured parameter of the one or more measured parameters that corresponds to the first uBS; and
sending, to the UE, a first reconfiguration request message comprising a first RACH configuration for the UE to use to connect to the first uBS.

9. The method of claim 8, further comprising:
identifying a second uBS of the one or more uBSs to add to the cluster for serving the UE based on a second measured parameter of the one or more measured parameters that corresponds to the second uBS; and
sending, to the UE, a second reconfiguration request message comprising a second RACH configuration for the UE to use to connect to the second uBS.

10. The method of claim 8, wherein the cell detection report is unencrypted.

11. The method of claim 8, wherein the first measured parameter is a reference signal received power (RSRP) value.

12. A method of a clustering control function (CCF) of a wireless communication system, comprising:
receiving, from a first base station of the wireless communication system, a first measured parameter for a user equipment (UE), the first measured parameter corresponding a first message of a first random access channel (RACH) procedure between the first base station and the UE;
determining, based on the first measured parameter, that the first base station is to be added to a cluster for serving the UE; and
sending, to the UE, a first reconfiguration request message comprising a first RACH configuration for the UE to use to connect to the first base station.

13. The method of claim 12, further comprising:
receiving, from a second base station of the wireless communication system, a second measured parameter for the UE, the second measured parameter corresponding a second message of a second RACH procedure between the second base station and the UE;
determining, based on the second measured parameter, that the second base station is to be added to the cluster for serving the UE; and
sending, to the UE, a second reconfiguration request message comprising a second RACH configuration for the UE to use to connect to the second base station.

14. The method of claim 12, wherein the first message of the first RACH procedure is one of a random access (RA) preamble, a message 3, or a first message after conflict resolution.

15. The method of claim 12, wherein the first measured parameter is a reference signal received power (RSRP) value.
